(19) United States
(12) Patent Application Publication
(10) Pub. No.: US 2026/0180818 A1
(43) Pub. Date: Jun. 25, 2026

(54) CONFERENCE SUPPORT APPARATUS, SYSTEM, AND METHOD, AND COMPUTER-READABLE MEDIUM

(71) Applicant: NEC Corporation, Minato-ku, Tokyo (JP)

(72) Inventor: Shiori Sugimoto, Tokyo (JP)

(73) Assignee: NEC Corporation, Minato-ku, Tokyo (JP)

(21) Appl. No.: 18/726,519

(22) PCT Filed: Mar. 22, 2022
(86) PCT No.: PCT/JP2022/012977

§ 371 Date: Jul. 3, 2024

(51) Int. Cl. H04L 12/18; H04L 65/403; H04M 3/56

(52) U.S. Cl. CPC H04L 12/1818; H04L 12/1822; H04L 65/403; H04M 3/56

(57) ABSTRACT

A conference support apparatus includes: an acquisition unit that acquires a first authentication result of an attendee specified by personal authentication when attending an online conference including attendance in a conference room and remote attendance from outside the conference room; a determination unit that determines whether an attendance form of the attendee for the online conference is conference room attendance or remote attendance based on the acquisition source of the first authentication result; an update unit that updates attendance status display information so that the determined attendance form can be identified for the attendee; and an output unit that outputs the attendance status display information.

### TECHNICAL FIELD

The present disclosure relates to a conference support apparatus, system, and method and a program.

### BACKGROUND ART

Patent Literature 1 discloses a technology related to a face authentication conference system. The face authentication conference system according to Patent Literature 1 captures an image of a face of an attendee at a conference, and issues an alarm when the captured face photo is not included in face photograph data of persons scheduled to attend the conference.

In recent years, online conference systems have become widespread, and conference attendance forms have been diversified. For example, a plurality of attendees may gather in each of conference rooms of a plurality of bases to transmit and receive video and audio between online conference facilities of the conference rooms, or terminals of the attendees may be connected to a common online conference system.

### CITATION LIST

### Patent Literature

Patent Literature 1: Japanese Unexamined Patent Application Publication No. 2015-099537

### SUMMARY OF INVENTION

### Technical Problem

Here, there is a problem that it is difficult to identify substantial attendees and absentees in real time in an online conference in which attendees gathered in a conference room and attendees at remote locations are mixed.

In view of the above-described problems, an object of the present disclosure is to provide a conference support apparatus, system, and method and a program for supporting real-time identification of substantial attendees and absentees in an online conference in which attendees in a conference room and attendees at remote locations are mixed.

### Solution to Problem

A conference support apparatus according to the present disclosure includes:
an acquisition means for acquiring a first authentication result of an attendee specified by personal authentication when attending an online conference including attendance in a conference room and remote attendance from outside the conference room;
a determination means for determining whether an attendance form of the attendee for the online conference is conference room attendance or remote attendance based on an acquisition source of the first authentication result;
an update means for updating attendance status display information so that the determined attendance form can be identified for the attendee; and
an output means for outputting the attendance status display information.

A conference support system according to the present disclosure includes:
an authentication apparatus that performs personal authentication of an attendee of an online conference including attendance in a conference room and remote attendance from outside the conference room; and
a conference support apparatus connected to the authentication apparatus.

The conference support apparatus includes:
an acquisition means for acquiring a first authentication result of an attendee specified by personal authentication when attending the online conference;
a determination means for determining whether an attendance form of the attendee for the online conference is conference room attendance or remote attendance based on an acquisition source of the first authentication result;
an update means for updating attendance status display information so that the determined attendance form can be identified for the attendee; and
an output means for outputting the attendance status display information.

A conference support method according to the present disclosure causes a computer to:
acquire a first authentication result of an attendee specified by personal authentication when attending an online conference including attendance in a conference room and remote attendance from outside the conference room;
determine whether an attendance form of the attendee for the online conference is conference room attendance or remote attendance based on an acquisition source of the first authentication result;
update attendance status display information so that the determined attendance form can be identified for the attendee; and
output the attendance status display information.

A conference support program according to the present disclosure causes a computer to execute:
acquisition processing for acquiring a first authentication result of an attendee specified by personal authentication when attending an online conference including attendance in a conference room and remote attendance from outside the conference room;
determination processing for determining whether an attendance form of the attendee for the online conference is conference room attendance or remote attendance based on an acquisition source of the first authentication result;
update processing for updating attendance status display information so that the determined attendance form can be identified for the attendee; and
output processing for outputting the attendance status display information.

### Advantageous Effects of Invention

According to the present disclosure, it is possible to provide a conference support apparatus, system, and method and a program for supporting real-time identification of substantial attendees and absentees in an online conference in which attendees in a conference room and attendees at remote locations are mixed.

### BRIEF DESCRIPTION OF DRAWINGS

FIG. 1 is a block diagram illustrating the configuration of a conference support apparatus according to a first example embodiment.

FIG. 2 is a flowchart illustrating a flow of a conference support method according to the first example embodiment.

FIG. 3 is a block diagram illustrating the configuration of a conference support system according to a second example embodiment.

FIG. 4 is a block diagram illustrating the configuration of an authentication apparatus according to the second example embodiment.

FIG. 5 is a flowchart illustrating a flow of face information registration processing by the authentication apparatus according to the second example embodiment.

FIG. 6 is a diagram illustrating a configuration example of conference information according to the second example embodiment.

FIG. 7 is a diagram illustrating an example of a scheduled attendee list according to the second example embodiment.

FIG. 8 is a block diagram illustrating the configuration of a conference support apparatus according to the second example embodiment.

FIG. 9 is a sequence diagram illustrating a flow of conference support processing according to the second example embodiment.

FIG. 10 is a sequence diagram illustrating a flow of conference support processing according to the second example embodiment.

FIG. 11 is a flowchart illustrating a flow of face authentication processing by the authentication apparatus according to the second example embodiment.

FIG. 12 is a flowchart illustrating a flow of conference support processing in the conference support apparatus according to the second example embodiment.

FIG. 13 is a diagram illustrating a display example of attendance status display information according to the second example embodiment.

FIG. 14 is a flowchart illustrating a flow of attendance permission processing for an unregistered person according to the second example embodiment.

FIG. 15 is a diagram illustrating a display example of attendance status display information according to the second example embodiment.

FIG. 16 is a diagram for describing a concept of display of attendance status display information according to a modified example of the second example embodiment.

FIG. 17 is a flowchart illustrating a flow of conference support processing in a conference support apparatus according to a third example embodiment.

FIG. 18 is a diagram illustrating a display example of attendance status display information according to the third example embodiment.

FIG. 19 is a flowchart illustrating a flow of conference support processing in a conference support apparatus according to a fourth example embodiment.

FIG. 20 is a diagram illustrating a display example of attendance status display information according to the fourth example embodiment.

FIG. 21 is a diagram illustrating a display example of attendance status display information according to another example embodiment.

### EXAMPLE EMBODIMENT

Hereinafter, example embodiments of the present disclosure will be described in detail with reference to the drawings. In the drawings, the same or corresponding elements are denoted by the same reference numerals, and redundant description is omitted as necessary for clarity of description.

### First Example Embodiment

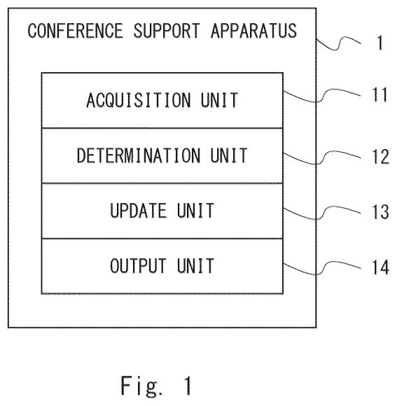

FIG. 1 is a block diagram illustrating the configuration of a conference support apparatus 1 according to a first example embodiment. The conference support apparatus 1 is an information processing apparatus for managing an attendance status of an online conference including attendance in a conference room and remote attendance from outside the conference room. The conference support apparatus 1 includes an acquisition unit 11, a determination unit 12, an update unit 13, and an output unit 14.

The acquisition unit 11 acquires a first authentication result of an attendee specified by personal authentication when attending the online conference. Here, the personal authentication is, for example, biometric authentication such as face authentication in an authentication terminal or an information terminal, authentication processing when attending an online conference, and personal authentication using an integrated circuit (IC) card or the like storing electronic personal authentication information, but is not limited thereto.

Then, the acquisition unit 11 may acquire, from the authentication terminal, a result of the personal authentication performed in an authentication terminal (not illustrated) that performs the personal authentication at least when entering the conference room. In this case, it is assumed that the authentication terminal is installed inside or outside the conference room (for example, near the doorway). In this case, the acquisition source of the first authentication result is the authentication terminal. Alternatively, the acquisition unit 11 may acquire a result of personal authentication performed regarding attendance at the online conference from a conference system (not illustrated) that manages the online conference. In this case, the acquisition source of the first authentication result is the conference system.

The determination unit 12 determines whether the attendance form of the attendee for the conference is conference room attendance or remote attendance based on the acquisition source of the first authentication result. For example, when the acquisition source is the authentication terminal, the determination unit 12 determines that the attendance form is conference room attendance. On the other hand, when the acquisition source is the above-described conference system, the determination unit 12 determines that the attendance form is remote attendance.

The update unit 13 updates the attendance status display information so that the attendance form determined by the determination unit 12 can be identified for the attendees. Here, the attendance status display information is information for displaying the attendance status in the online conference. It is assumed that “updating the attendance status display information” includes that the update unit 13 newly generates the attendance status display information when the attendance status display information in the online conference has not been generated.

The output unit 14 outputs the attendance status display information updated by the update unit 13. For example, the output unit 14 transmits the attendance status display information to the terminals of the online conference attendees and persons scheduled to attend the online conference. In addition, the output unit 14 transmits the attendance status display information to the display apparatus installed in the conference room. In addition, the output unit 14 transmits the attendance status display information to the authentication terminal. In addition, the output unit 14 transmits the attendance status display information to the online conference system.

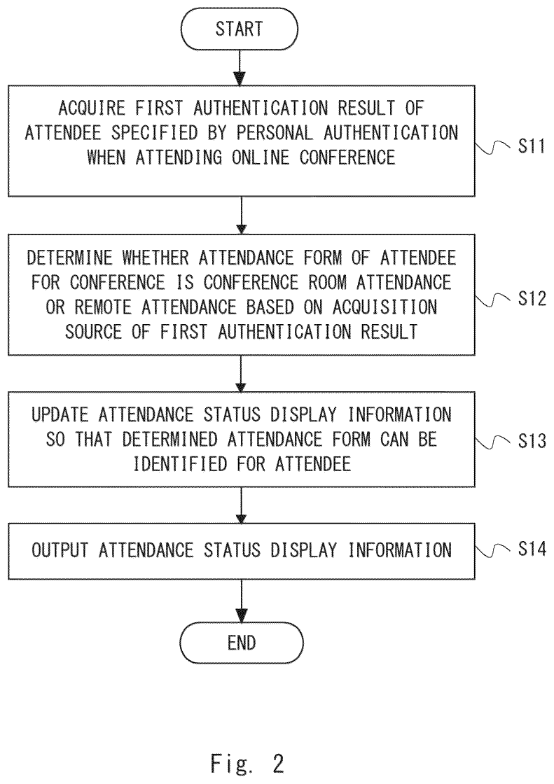

FIG. 2 is a flowchart illustrating a flow of a conference support method according to the first example embodiment. First, the acquisition unit 11 acquires the first authentication result of the attendee specified by the personal authentication when attending the online conference including attendance at the conference room and remote attendance from outside the conference room (S11). Then, the determination unit 12 determines whether the attendance form of the attendee for the conference is conference room attendance or remote attendance based on the acquisition source of the first authentication result (S12). Then, the update unit 13 updates the attendance status display information so that the attendance form determined in step S12 can be identified for the attendee (S13). Thereafter, the output unit 14 outputs the attendance status display information (S14).

As described above, the attendance status display information according to the present example embodiment enables a person involved in the online conference to identify an attendance form for each attendee at the conference. Therefore, it is possible to support real-time identification of substantial attendees and absentees in the online conference in which attendees in a conference room and attendees at remote locations are mixed.

Note that the conference support apparatus 1 includes a processor, a memory, and a storage device as components (not illustrated). In addition, the storage device stores a computer program in which the processing of the conference support method according to the present example embodiment is implemented. Then, the processor reads the computer program or the like from the storage device into the memory and executes the computer program. As a result, the processor implements the functions of the acquisition unit 11, the determination unit 12, the update unit 13, and the output unit 14.

Alternatively, each component of the conference support apparatus 1 may be implemented by dedicated hardware. In addition, some or all of the components of each apparatus may be implemented by general-purpose or dedicated circuitry, a processor, or a combination thereof. These may be configured by a single chip or may be configured by a plurality of chips connected to each other through a bus. Some or all of the components of each apparatus may be implemented by, for example, a combination of the above-described circuitry and a program. In addition, for example, a central processing unit (CPU), a graphics processing unit (GPU), a field-programmable gate array (FPGA), or a quantum processor (quantum computer control chip) can be used as the processor.

### Second Example Embodiment

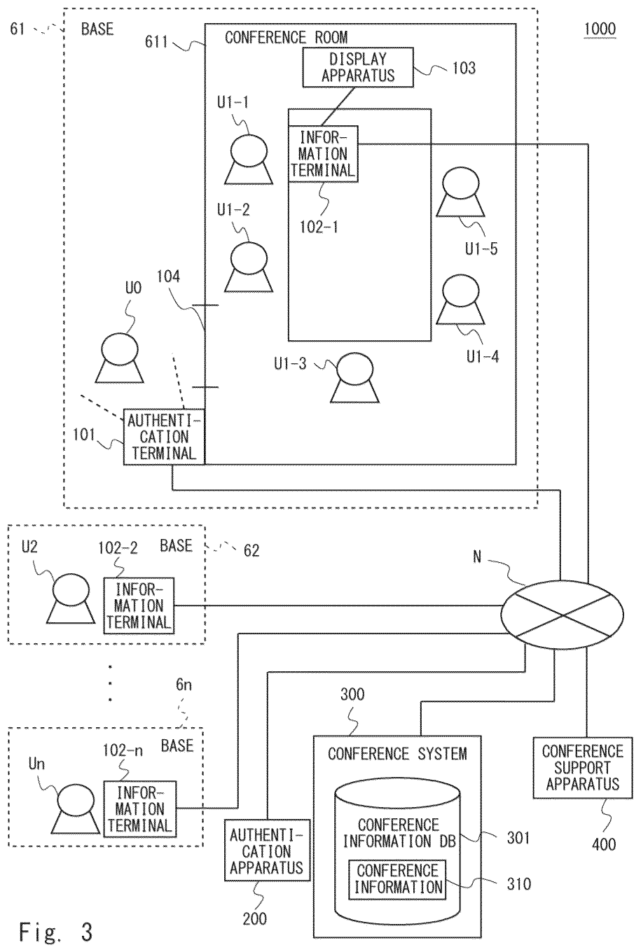

A second example embodiment is a specific example of the first example embodiment described above. FIG. 3 is a block diagram illustrating the configuration of a conference support system 1000 according to the second example embodiment. The conference support system 1000 is an information system for managing an attendance status of an online conference including attendance in a conference room and remote attendance from outside the conference room. Here, a case where a predetermined online conference is held by connecting a conference room 611 of a base 61, a base 62, . . . , and a base 6n (n is a natural number of 2 or more) will be exemplified.

The conference support system 1000 includes an authentication terminal 101, information terminals 102-1 to 102-n, a display apparatus 103, an authentication apparatus 200, a conference system 300, and a conference support apparatus 400. The authentication terminal 101, the information terminals 102-1 to 102-n, the authentication apparatus 200, the conference system 300, and the conference support apparatus 400 are communicably connected to each other through a network N. Note that the display apparatus 103 may also be communicably connected through the network N. Here, the network N is a wired or wireless communication line or communication network, and is, for example, a local area network (LAN), the Internet, a wireless communication line network, and a mobile phone line network. The network N may be of any type of communication protocol.

The conference room 611 is a main venue for the online conference, and at least two or more people gather. It is assumed that the authentication terminal 101 is installed in the vicinity of the entrance (door 104) of the conference room 611 and, when a scheduled attendee U0 enters the conference room 611, personal authentication by the authentication terminal 101 needs to be successful. Therefore, it is assumed that conference room attendees U1-1 to U1-5 in the conference room 611 have succeeded in the personal authentication by the authentication terminal 101.

In the conference room 611, the information terminal 102-1 and the display apparatus 103 are installed. In addition, a camera, a microphone, and a speaker for the online conference may be installed in the conference room 611. The information terminal 102-1 and the display apparatus 103 are communicably connected to each other in a wired or wireless manner. The display apparatus 103 may display a screen of the online conference output from the information terminal 102-1 or attendance status display information to be described later.

It is assumed that conference room attendees U1-1 to U1-5 are seated in the seats of the conference table of the conference room 611 to attend the online conference. In addition, for example, the conference room attendee U1-1 may be an organizer of the online conference. It is assumed that the conference room attendee U1-1 operates the information terminal 102-1 to start or proceed with the online conference. The conference room attendees U1-2 to U1-5 may attend the online conference without using their information terminals. That is, the conference room attendees U1-2 to U1-5 participate in the conference from the local conference room 611, and can also be said to participate offline. In this case, the conference room attendees U1-2 to U1-5 communicate with the remote attendees U2 to Un of the online conference located at remote locations through the camera, the microphone, and the speaker installed in the conference room 611 or built in the information terminal 102-1, and the screen of the display apparatus 103. Alternatively, at least some of the conference room attendees U1-2 to U1-5 may attend the online conference using the information terminal 102.

The remote attendee U2 at the base 62 attends the online conference using the information terminal 102-2. Similarly, the remote attendee Un at the remote attendee Un attends the online conference using the information terminal 102-n. In any of the bases 62 to 6n (other bases), similarly to the conference room 611, a plurality of people may attend the online conference from the conference room that requires successful personal authentication when entering the room. At that time, some of the conference attendees in the conference rooms of other bases may attend the online conference without using their information terminals, similarly to the conference room attendees U1-2 and the like. That is, some of the conference attendees in the conference room in another base may participate in the conference from the local conference room (offline participation). In addition, the organizer of the conference does not necessarily need to be the attendee of the conference room 611. For example, the organizer of the conference may be a remote attendee who does not participate in the conference from a local conference room. For example, the organizer of the conference may be a remote attendee in another base other than the base 61.

In the following description, the conference room attendees U1-1 to U1-5 in the conference room 611 may be collectively referred to as a “conference room attendee U1”. In addition, the conference room attendee Ul and the remote attendees U2 to Un may be collectively referred to as a “conference attendee”. In addition, the scheduled attendee U0 and the conference attendees may be collectively referred to as a “user U”. In addition, it is assumed that the information terminals 102-1 to 102-n have the same function, and may be referred to as an “information terminal 102” in the following description.

The authentication terminal 101 controls personal authentication, and when the personal authentication is successful, permits entry into the conference room 611 and transmits the authentication result to the conference support apparatus 400 through the network N. For example, the authentication terminal 101 performs face authentication using a captured image including the face of the scheduled attendee U0 by a built-in camera. At this time, the authentication terminal 101 transmits a face authentication request including the captured image to the authentication apparatus 200 through the network N, and receives a face authentication result from the authentication apparatus 200. Then, the authentication terminal 101 transmits the face authentication result to the conference support apparatus 400 through the network N. In addition, when permitting entry, the authentication terminal 101 performs control to unlock the door 104 of the conference room 611.

The information terminal 102 is an information processing apparatus such as a tablet terminal, a smartphone, a notebook personal computer (PC), or a desktop PC. For example, it is assumed that software for communicating with the conference system 300 to attend (participate in) an online conference and software for receiving the attendance status display information according to the present example embodiment and displaying the information on the screen are installed in the information terminal 102. Note that known software can be used as the software for attending the online conference.

The display apparatus 103 includes a screen such as a liquid crystal display, and displays display contents of the online conference or attendance status display information output from the information terminal 102-1 on the screen. Note that the display apparatus 103 may be usable in a so-called video conference system.

The authentication apparatus 200 is an information processing apparatus that manages face feature information of the user and performs face authentication. In response to the face authentication request received from the outside, the authentication apparatus 200 compares the face image or the face feature information included in the request with the face feature information of each user, and returns the comparison result (authentication result) to the request source.

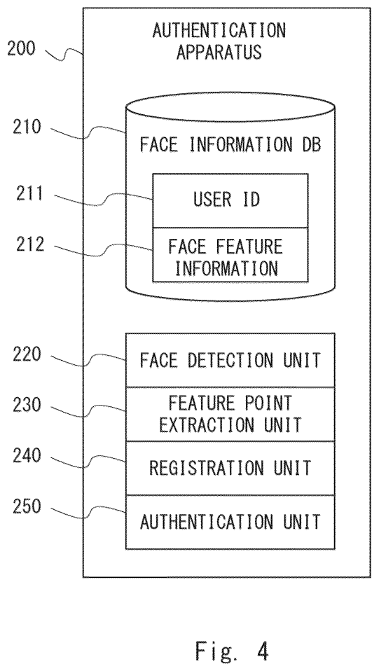

FIG. 4 is a block diagram illustrating the configuration of the authentication apparatus 200 according to the second example embodiment. The authentication apparatus 200 includes a face information database (DB) 210, a face detection unit 220, a feature point extraction unit 230, a registration unit 240, and an authentication unit 250. The face information DB 210 stores a user ID 211 and face feature information 212 of the user ID in association with each other. The face feature information 212 is a set of feature points extracted from the face image. Note that the authentication apparatus 200 may delete the face feature information 212 in the face information DB210 in response to a request from the user or the like corresponding to the face feature information 212. Alternatively, the authentication apparatus 200 may delete the face feature information 212 after the elapse of a predetermined period from registration.

The face detection unit 220 detects a face region included in a registered image for registering face information, and outputs the face region to the feature point extraction unit 230. The feature point extraction unit 230 extracts feature points from the face region detected by the face detection unit 220, and outputs the face feature information to the registration unit 240. In addition, the feature point extraction unit 230 extracts feature points included in the face image received from the conference support apparatus 400 or the like, and outputs the face feature information to the authentication unit 250.

The registration unit 240 newly issues the user ID 211 when registering the face feature information. The registration unit 240 registers the issued user ID 211 and the face feature information 212 extracted from the registration image in the face information DB 210 in association with each other. The authentication unit 250 performs face authentication using the face feature information 212. Specifically, the authentication unit 250 compares the face feature information extracted from the face image with the face feature information 212 in the face information DB 210. When the comparison is successful, the authentication unit 250 specifies the user ID 211 associated with the compared face feature information 212. The authentication unit 250 returns the matching result of the face feature information to the request source as a face authentication result. Whether or not the pieces of face feature information match each other corresponds to whether or not authentication has succeeded or failed. The fact that the pieces of face feature information match each other means that the degree of matching is equal to or greater than a threshold value. In addition, it is assumed that the face authentication result includes the specified user ID when the face authentication has succeeded.

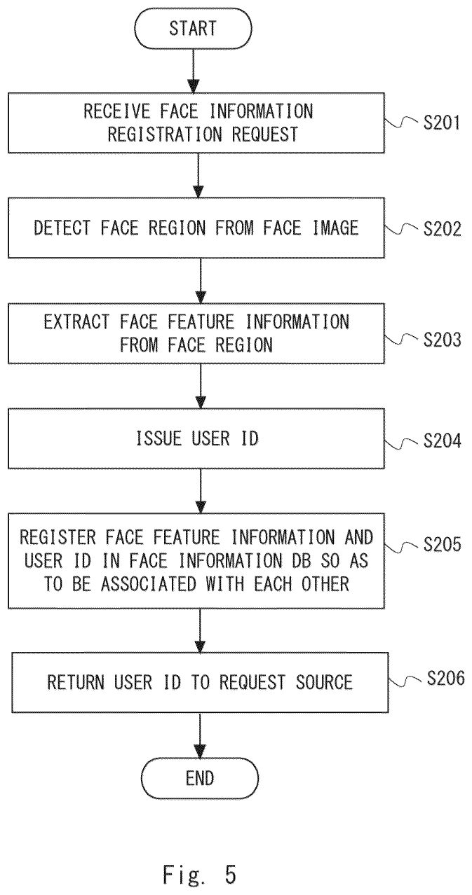

FIG. 5 is a flowchart illustrating a flow of face information registration processing by the authentication apparatus 200 according to the second example embodiment. First, the authentication apparatus 200 receives a face information registration request (S201). For example, the authentication apparatus 200 receives a face information registration request from the conference support apparatus 400 through the network N. Then, the face detection unit 220 detects a face region from the face image included in the face information registration request (S202). Then, the feature point extraction unit 230 extracts feature points (face feature information) from the face region detected in step S202 (S203). Then, the registration unit 240 issues the user ID 211 (S204). Then, the registration unit 240 registers the extracted face feature information 212 and the issued user ID 211 in the face information DB 210 so as to be associated with each other (S205). Thereafter, the registration unit 240 returns the issued user ID 211 to the request source (for example, the conference support apparatus 400) (S206). The authentication apparatus 200 may perform the face information registration processing in response to the face information registration request received from any information registration terminal. For example, the information registration terminal is an information processing apparatus, such as a personal computer, a smartphone, or a tablet terminal.

Returning to FIG. 3, the description will continue.

The conference system 300 is an information system including a server that provides an online conference service. The conference system 300 includes a conference information DB301 that manages conference information 310. The conference system 300 receives a conference attendance request for the preset conference information 310 from each of the plurality of information terminals 102, performs conference attendance processing, and returns a conference attendance notification. At this time, the conference system 300 transmits the authentication result of the remote attendees to the conference, including the user IDs of the attendees included in the conference attendance request and the system ID of the conference system 300, to the conference support apparatus 400 through the network N.

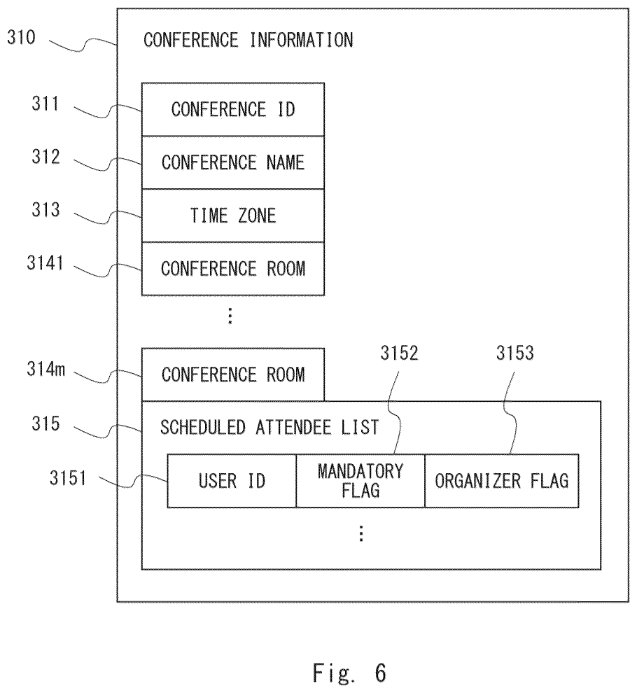

FIG. 6 is a diagram illustrating a configuration example of the conference information 310 according to the second example embodiment. The conference information 310 is setting information of an online conference including attendance in a conference room and remote attendance from outside the conference room. The conference information 310 is, for example, information in which a conference ID 311, a conference name 312, a time zone 313, conference rooms 3141 to 314m (m is a natural number of 1 or more), and a scheduled attendee list 315 are associated with each other. The conference ID 311 is identification information of the target online conference. The conference name 312 is text information of the name of the target online conference. The time zone 313 is a set of start time and end time of the target online conference. The conference room 3141 and the like are information about a conference room used in the target online conference. In the conference information 310, the conference room 3141 and the like may not be set. In this case, the conference information 310 can be said to be setting information of a normal online conference. In the conference information 310, two or more conference rooms 3141 and the like may be set. That is, this may be an online conference performed by connecting conference rooms in which there are attendees (not using information terminals) between a plurality of bases.

The scheduled attendee list 315 is a list of users set in advance as scheduled attendees of the target online conference. In the scheduled attendee list 315, a user ID 3151, a mandatory flag 3152, and an organizer flag 3153 are associated with one record per scheduled attendee. Then, the scheduled attendee list 315 includes two or more records. The user ID 3151 is identification information of the scheduled attendee. The mandatory flag 3152 is flag information indicating whether the scheduled attendee is a mandatory attendee in the target online conference. The organizer flag 3153 is flag information indicating whether the scheduled attendee is an organizer in the target online conference.

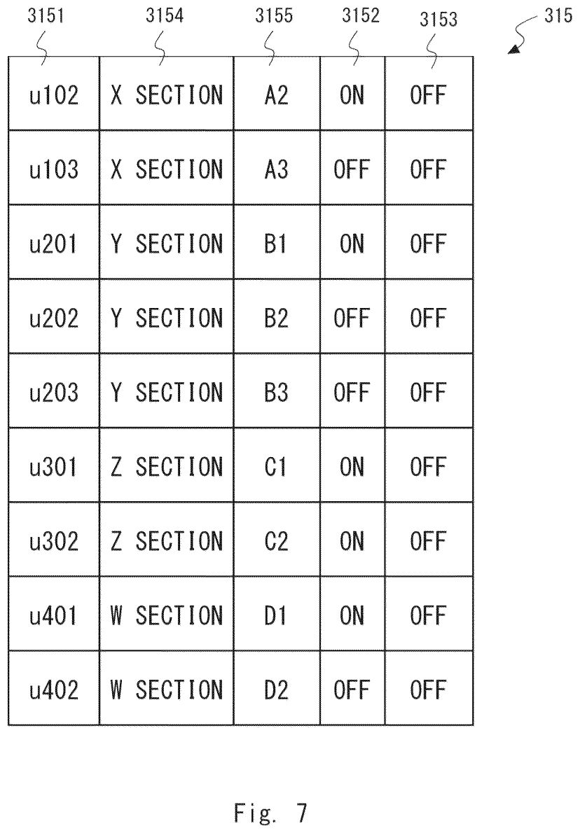

FIG. 7 is a diagram illustrating an example of the scheduled attendee list 315 according to the second example embodiment. Here, an example is illustrated in which the scheduled attendee list 315 includes a belonging group 3154 and a user name 3155 in addition to the user ID 3151, the mandatory flag 3152, and the organizer flag 3153 described above. When the mandatory flag 3152 is ON, the mandatory flag 3152 indicates that the corresponding user is a mandatory attendee at the conference, and when the mandatory flag 3152 is OFF, the mandatory flag 3152 indicates that the corresponding user is any attendee at the conference. When the organizer flag 3153 is ON, the organizer flag 3153 indicates that the corresponding user is the organizer of the conference, and when the organizer flag 3153 is OFF, the organizer flag 3153 indicates that the corresponding user is not the organizer of the conference. The belonging group 3154 and the user name 3155 may be included in the user information 412 managed by the conference support apparatus 400 to be described later. Therefore, the scheduled attendee list 315 may be information in which at least the user ID 3151, the mandatory flag 3152, and the organizer flag 3153 described above are associated with each other. An unregistered person who is not registered in the scheduled attendee list 315 may not be allowed to attend the conference. Alternatively, an unregistered person may be allowed to attend if additional attendance or proxy attendance procedures are followed.

Returning to FIG. 3, the description will continue.

The conference support apparatus 400 is an example of the conference support apparatus 1 described above. The conference support apparatus 400 is an information processing apparatus for managing an attendance status of an online conference including attendance in the conference room 611 and remote attendance from the base 62 or the like. The conference support apparatus 400 may be configured redundantly in a plurality of servers, and each functional block may be implemented by a plurality of computers.

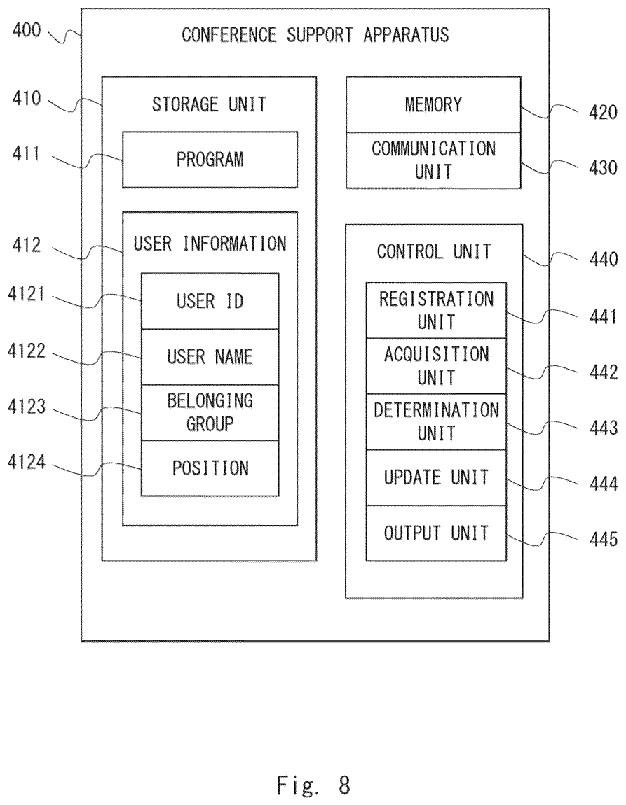

FIG. 8 is a block diagram illustrating the configuration of the conference support apparatus 400 according to the second example embodiment. The conference support apparatus 400 includes a storage unit 410, a memory 420, a communication unit 430, and a control unit 440. The storage unit 410 is an example of a storage device such as a hard disk or a flash memory. The storage unit 410 stores a program 411 and user information 412. The program 411 is a computer program (conference support program) in which conference support processing and the like according to the second example embodiment are implemented.

The user information 412 is information for managing users who can attend the online conference from each base. The user information 412 is information in which a user ID 4121, a user name 4122, a belonging group 4123, and a position 4124 are associated with each other. The user ID 4121 is identification information of the target user. The user ID 4121 is information that is the same as or uniquely corresponds to the user ID 211 managed in association with the face feature information 212 in the face information DB210 of the authentication apparatus 200. Therefore, the user information 212 can be said to be information associated with the feature information for user registration (biometric information, personal authentication information, personal identification information, and the like) through the user ID 2121. The user name 4122 is a name or the like of the target user. The belonging group 4123 is information indicating a group to which the target user belongs. The position 4124 is information for identifying the position of the target user, for example, whether or not the target user is a representative in the belonging group.

The storage unit 410 only needs to store at least the program 411. Therefore, the user information 412 may be stored in an external storage device connected to the conference support apparatus 400. In addition, the storage unit 410 may store the conference information 310 described above. In addition, the storage unit 410 or the memory 420 may store attendance status display information to be described later, data indicating the attendance status, and the like.

The memory 420 is a volatile storage device such as a random access memory (RAM), and is a storage area for temporarily storing information during an operation of the control unit 440. The communication unit 430 is a communication interface with the network N.

The control unit 440 is a processor that controls each component of the conference support apparatus 400, that is, a control apparatus. The control unit 440 reads the program 411 from the storage unit 410 into the memory 420 and executes the program 411. As a result, the control unit 440 implements the functions of the registration unit 441, the acquisition unit 442, the determination unit 443, the update unit 444, and the output unit 445.

The registration unit 441 registers the user information 412. For example, the registration unit 441 receives the user ID 4121, the user name 4122, the belonging group 4123, and the position 4124 from the terminal of any user U, generates the user information 412 by associating these with each other, and registers the user information 412 in the storage unit 410. In addition, in this case, the registration unit 441 may cause the authentication apparatus 200 to register the face information. For example, the registration unit 441 receives a registration request including the user name 4122, the belonging group 4123, the position 4124, and the face image of the user from the terminal, and transmits a face information registration request including the face image included in the registration request to the authentication apparatus 200 through the network N. Then, the registration unit 441 receives the user ID issued at the time of face information registration from the authentication apparatus 200. Then, the registration unit 441 registers the user name 4122, the belonging group 4123, and the position 4124 included in the registration request in the storage unit 410 as the user information 412 in association with the issued user ID 4121. Note that the registration unit 441 may register the above-described scheduled attendee list 315 in the conference system 300 in response to a conference information registration request from the terminal of the organizer of the online conference.

The acquisition unit 442 is an example of the acquisition unit 11 described above. The acquisition unit 442 acquires an authentication result from the authentication terminal 101 or the conference system 300 through the network N. The authentication result includes the user ID of the attendee specified by the personal authentication when attending the target online conference, the terminal ID of the authentication terminal 101, or the system ID of the conference system 300.

The acquisition unit 442 may acquire attendance permission including a reason for attendance of an unregistered person from any of the scheduled attendees included in the scheduled attendee list. Specifically, the acquisition unit 442 may acquire attendance permission including a reason for attendance of an unregistered person as an additional attendance from attendees other than unregistered persons among the scheduled attendees included in the scheduled attendee list. In addition, the acquisition unit 442 may acquire attendance permission including a reason for attendance of an unregistered person as proxy attendance for the absentee from the absentee among the scheduled attendees included in the scheduled attendee list.

The determination unit 443 is an example of the determination unit 12 described above. The determination unit 443 determines whether the attendance form of the attendee at the conference is attendance in the conference room or remote attendance based on the acquisition source of the authentication result acquired by the acquisition unit 442. Specifically, when the terminal ID of the authentication terminal 101 is included in the authentication result, the determination unit 443 determines that the attendance form of the attendee corresponding to the user ID included in the authentication result is conference room attendance. On the other hand, when the system ID of the conference system 300 is included in the authentication result, the determination unit 443 determines that the attendance form of the attendee corresponding to the user ID included in the authentication result is the remote attendance.

In addition, the determination unit 443 determines the attendance status of each scheduled attendee included in the scheduled attendee list based on the scheduled attendee list of the online conference and the authentication result. In particular, when the attendee in the authentication result is not included in the scheduled attendee list, the determination unit 443 determines that the attendee is an unregistered person. In addition, the determination unit 443 determines, as a non-attendee, a person other than the attendees among the scheduled attendees included in the scheduled attendee list.

The update unit 444 is an example of the update unit 13 described above. The update unit 444 updates the attendance status display information so that the attendance form determined by the determination unit 443 can be identified for the attendees. In addition, when the attendance form of a specific attendee corresponds to both “conference room attendance” and “remote attendance”, the update unit 444 may update the attendance status display information with the attendance form being “conference room attendance”. For example, when the conference room attendee U1-1 is an organizer of a conference, first, personal authentication has succeeded by the authentication terminal 101 when entering the conference room 611, and the attendance form corresponds to “conference room attendance”. Then, in order to start the online conference, the conference room attendee U1-1 makes a conference start request in the conference system 300 after succeeding in the personal authentication in the information terminal 102-1. Therefore, the attendance form of the conference room attendee U1-1 also corresponds to “remote attendance”. In such a case, since the conference room attendee U1-1 is one of the attendees in the conference room 611, it can be said that the conference room attendee U1-1 is substantially “conference room attendance” from the viewpoint of attendees from other bases. Therefore, in this example, the update unit 444 updates the attendance status display information with the attendance form of the conference room attendee U1-1 as “conference room attendance”.

In addition, the update unit 444 updates the attendance status display information reflecting the attendance status determined by the determination unit 443 for each scheduled attendee included in the scheduled attendee list. Specifically, the update unit 444 updates the attendance status display information by adding a notation indicating the fact to the unregistered person. In addition, the update unit 444 may update the attendance status display information so that each scheduled attendee included in the scheduled attendee list is displayed by being classified into any one of conference room attendance, remote attendance, and absence.

In addition, when a reason for attendance of an unregistered person is acquired by the acquisition unit 442, the update unit 444 updates the attendance status display information by adding the reason for attendance to the unregistered person. Specifically, when a reason for attendance of an unregistered person is acquired as additional attendance by the acquisition unit 442, the update unit 444 updates the attendance status display information by adding the fact of additional attendance to the unregistered person. In addition, when a reason for attendance of an unregistered person is acquired as additional attendance by the acquisition unit 442, the update unit 444 updates the attendance status display information by adding the fact of proxy attendance for the absentee.

The output unit 445 is an example of the output unit 14 described above. The output unit 445 transmits the attendance status display information updated by the update unit 444 to the information terminal 102 through the network N. Note that the output unit 445 may transmit the attendance status display information to the authentication terminal 101, the display apparatus 103, and the conference system 300 through the network N. In addition, the output unit 445 may store the attendance status display information updated by the update unit 444 in the storage unit 410 or the memory 420.

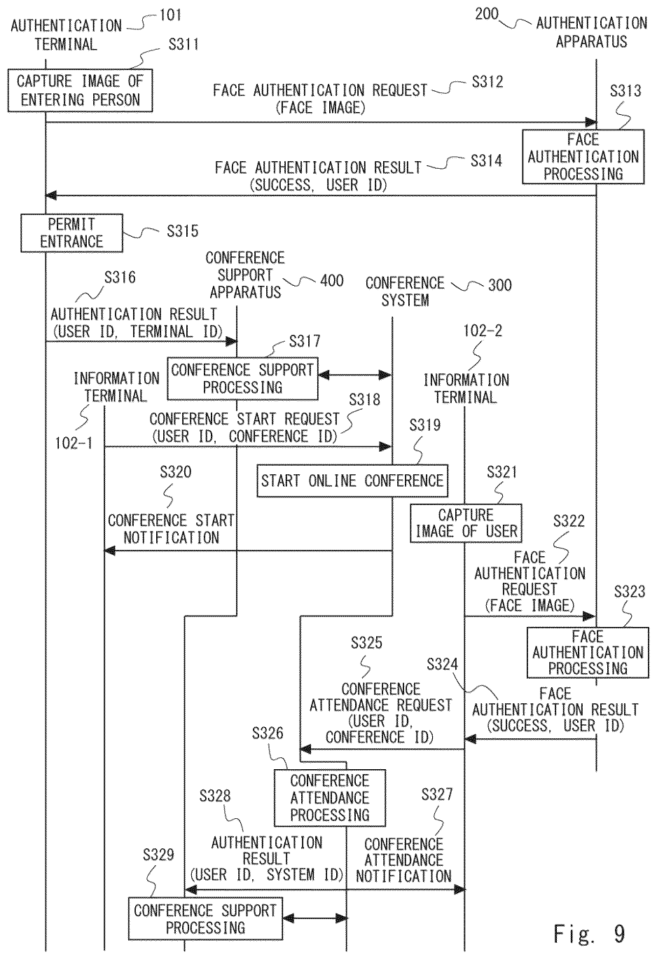

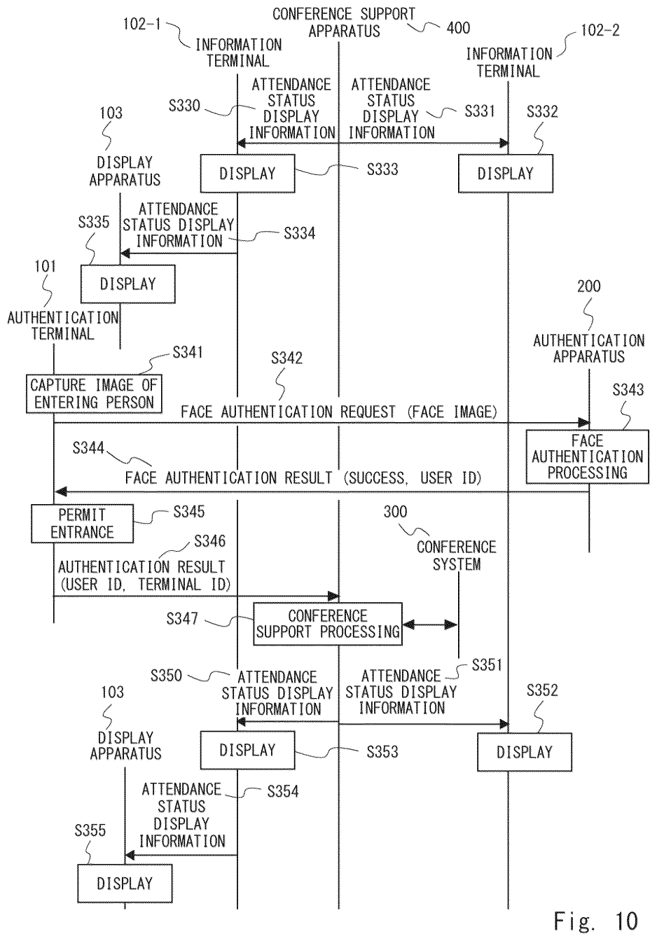

FIGS. 9 and 10 are sequence diagrams illustrating the flow of the conference support processing according to the second example embodiment. First, it is assumed that the scheduled attendee U0 at the base 61 is an organizer of a predetermined online conference and the above-described scheduled attendee list 315 in FIG. 7 has been registered in the conference system 300 in advance. In addition, it is assumed that the conference room 3141 of the conference information 310 is a conference room 611. Therefore, the scheduled attendee U0 goes to the conference room 611 before the start time of the conference, and performs personal authentication with the authentication terminal 101. Specifically, the authentication terminal 101 captures an image of the face of an entering person (scheduled attendee U0) who intends to enter the conference room 611 (S311). Then, the authentication terminal 101 transmits a face authentication request including the face image to the authentication apparatus 200 through the network N (S312). In response to this, the authentication apparatus 200 performs face authentication processing (S313).

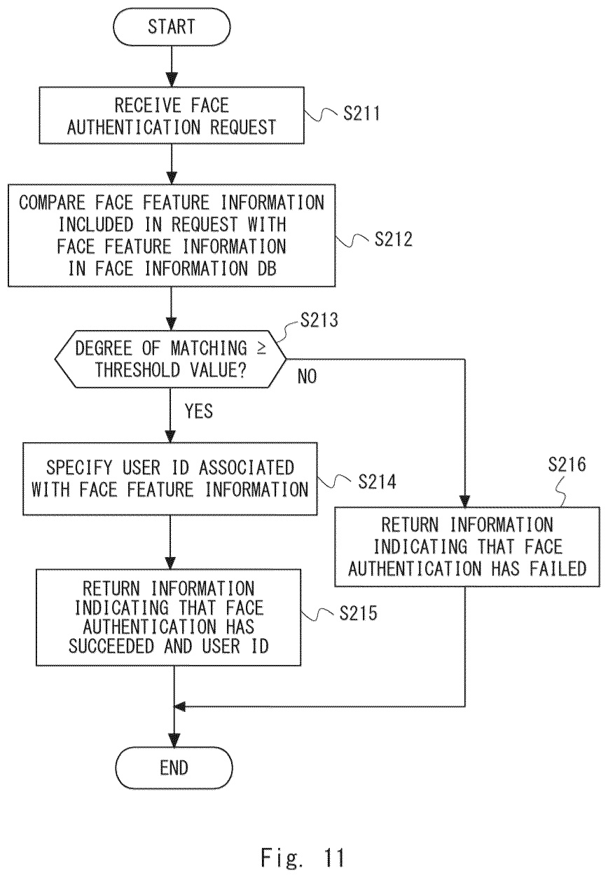

FIG. 11 is a flowchart illustrating a flow of face authentication processing performed by the authentication apparatus 200 according to the second example embodiment. First, the authentication apparatus 200 receives a face authentication request from the authentication terminal 101 through the network N (S211). Then, the authentication apparatus 200 extracts face feature information from the face image included in the face authentication request as in steps S202 and S203 described above. Then, the authentication unit 250 of the authentication apparatus 200 compares the face feature information extracted from the face image included in the face authentication request with the face feature information 212 of the face information DB 210 (S212), and calculates the degree of matching. Then, the authentication unit 250 determines whether or not the degree of matching is equal to or greater than a threshold value (S213). In a case in which the pieces of face feature information match each other, that is, in a case in which the degree of matching between the pieces of face feature information is equal to or greater than the threshold value, the authentication unit 250 specifies the user ID 211 associated with the face feature information 212 (S214). Then, the authentication unit 250 returns a face authentication result, which includes information indicating that the face authentication has succeeded and the specified user ID 211, to the authentication terminal 101 through the network N (S215). In a case in which the degree of matching is less than the threshold value in step S213, the authentication unit 250 returns a face authentication result, which includes information indicating that the face authentication has failed, to the authentication terminal 101 through the network N (S216).

Returning to FIG. 9, the description will be continued.

The authentication terminal 101 receives the face authentication result from the authentication apparatus 200 through the network N (S314). Then, the authentication terminal 101 determines whether the face authentication is successful. Specifically, the authentication terminal 101 refers to the face authentication result, and determines that the face authentication is successful when the user ID is included in the face authentication result. In this case, the authentication terminal 101 unlocks the door 104 of the conference room 611 to permit the scheduled attendee U0 to enter the room (S315). In this case, it is assumed that the scheduled attendee U0 is called a conference room attendee U1-1 in the conference room 611. In addition, when it is determined that the face authentication has failed, the authentication terminal 101 displays on the screen that entry of the scheduled attendee U0 is not permitted. When it is determined that the face authentication has succeeded, the authentication terminal 101 transmits the authentication result including the user ID included in the face authentication result and the terminal ID of the authentication terminal 101 to the conference support apparatus 400 through the network N (S316). In response to this, the conference support apparatus 400 acquires the authentication result from the authentication terminal 101 through the network N, and performs conference support processing (S317).

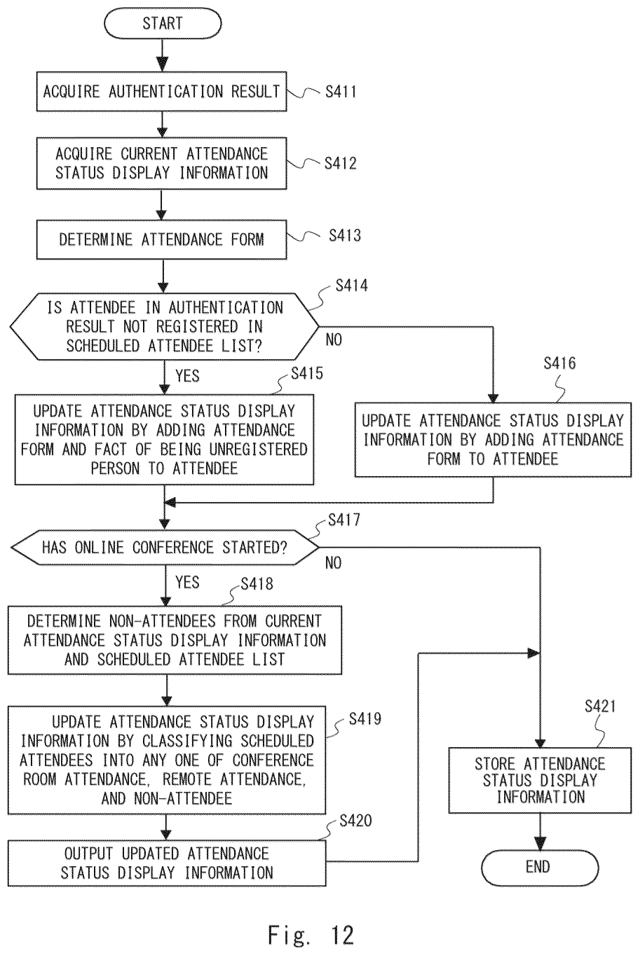

FIG. 12 is a flowchart illustrating a flow of conference support processing in the conference support apparatus according to the second example embodiment. As a premise, it is assumed that the conference support apparatus 400 has previously acquired the conference ID 311 of the conference information 310, which is the current time and the time zone 313 in a predetermined range, from the conference system 300 through the network N. That is, the conference support apparatus 400 determines that the conference ID of the target online conference has been specified.

Then, first, the conference support apparatus 400 acquires an authentication result from the authentication terminal 101 through the network N (S411). Then, the conference support apparatus 400 acquires the current attendance status display information in the target conference ID from the storage unit 410 or the memory 420 (S412). Note that the information held in the conference support apparatus 400 is not necessarily the attendance status display information, and may be “attendance status information” indicating at least the attendance status. In addition, at this point in time, since the online conference in the target conference ID has not started, there is no attendance status display information. Therefore, the conference support apparatus 400 may generate empty attendance status display information.

Then, the conference support apparatus 400 determines an attendance form from the acquired authentication result (S413). Here, since the acquisition source of the authentication result is the authentication terminal 101, the conference support apparatus 400 determines the attendance form of the attendee indicated by the user ID included in the authentication result as “conference room attendance”.

Subsequently, the conference support apparatus 400 determines whether the attendee in the authentication result is not registered in the scheduled attendee list (S414). For example, the conference support apparatus 400 transmits a registration confirmation request including the user ID included in the authentication result and the specified conference ID to the conference system 300 through the network N. In response to this, the conference system 300 searches for conference information DB 301, and specifies the conference information 310 corresponding to the received conference ID. Then, the conference system 300 determines whether the received user ID is included in the scheduled attendee list 315 of the specified conference information 310. When the user ID is not included, the conference system 300 returns the fact that the user is an unregistered person to the conference support apparatus 400 through the network N. On the other hand, when the user ID is included, the conference system 300 specifies the mandatory flag 3152 and the organizer flag 3153 associated with the user ID 3151. For example, in the case of the conference room attendee U1-1, both the mandatory flag 3152 and the organizer flag 3153 indicate “ON”. Then, the conference system 300 replies to the conference support apparatus 400 through the network N that the specified user ID 3151, the mandatory flag 3152, and the organizer flag 3153 are registered persons.

The conference support apparatus 400 determines whether the attendee is not registered in the scheduled attendee list according to the content received from the conference system 300. Note that the conference support apparatus 400 may acquire the scheduled attendee list 315 corresponding to the specified conference ID from the conference system 300 through the network N. Alternatively, the conference support apparatus 400 may periodically acquire the conference ID 311 and the scheduled attendee list 315 of the conference information 310, which is the current time and the time zone 313 in a predetermined range, from the conference system 300 through the network N. In these cases, the conference support apparatus 400 determines that the attendee is an unregistered person when the user ID included in the authentication result is not included in the acquired scheduled attendee list 315, and determines that the attendee is a registered person when the user ID is included.

When it is determined that the attendee is not registered (YES in S414), the conference support apparatus 400 updates the attendance status display information by adding the attendance form and the fact of being an unregistered person to the attendee (S415). On the other hand, when it is determined that the attendee is registered in S414 (NO in S414), the conference support apparatus 400 updates the attendance status display information by adding the attendance form to the attendee (S416). Here, adding the attendance form may be, for example, updating the display content in which the conference support apparatus 400 classifies the attendees into the group of the attendance form, or adding the notation of the attendance form to the attendee.

After step S415 or S416, the conference support apparatus 400 determines whether the target online conference has started (S417). Here, at this point in time, since the organizer has entered the conference room 611, it is determined that the online conference has not started (NO). Then, the conference support apparatus 400 stores the updated attendance status display information (S421).

The authentication terminal 101 may perform face authentication through the conference support apparatus 400. For example, the authentication terminal 101 may transmit the face authentication request to the conference support apparatus 400 through the network N. In this case, the conference support apparatus 400 transmits the received face authentication request to the authentication apparatus 200 through the network N, and receives a face authentication result from the authentication apparatus 200. Then, the conference support apparatus 400 regards the acquisition source of the received face authentication result as the authentication terminal 101, and performs the conference support processing.

Returning to FIG. 9, the description will be continued.

Thereafter, the conference room attendee U1-1 who is the organizer of the predetermined online conference and has entered the conference room 611 starts the online conference using the information terminal 102-1. Specifically, the information terminal 102-1 receives a conference ID (conference passcode), a user ID (or password), and the like input from the conference room attendee U1-1. Then, the information terminal 102-1 transmits a conference start request including at least the user ID, the conference ID, and the like to the conference system 300 through the network N (S318). In response to this, the conference support apparatus 400 starts an online conference corresponding to the conference ID included in the received conference start request (S319). Then, the conference system 300 returns a conference start notification to the information terminal 102-1 through the network N (S320). Note that the conference system 300 performs conference attendance processing by using the conference room attendee U1-1 as an attendee at the conference. Therefore, the conference system 300 may transmit the authentication result including the user ID, the conference ID, and the system ID of the conference room attendee U1-1 to the conference support apparatus 400 through the network N on the assumption that the conference room attendee U1-1 have succeeded in the authentication when attending the conference.

Thereafter, it is assumed that the remote attendee U2 at the base 62 attends the online conference using the information terminal 102-2. Specifically, the information terminal 102-2 captures an image of the face of the remote attendee U2 (S321). Then, the information terminal 102-2 transmits a face authentication request including the face image to the authentication apparatus 200 through the network N (S322). In response to this, the authentication apparatus 200 performs face authentication processing (S323).

The information terminal 102-2 receives the face authentication result from the authentication apparatus 200 through the network N (S324). Here, it is assumed that the remote attendee U2 has succeeded in the face authentication. Therefore, the information terminal 102-2 transmits a conference attendance request including the user ID and the conference ID included in the face authentication result to the conference system 300 through the network N (S325). Then, in the conference system 300, the remote attendee U2 corresponding to the user ID performs conference attendance processing of the conference corresponding to the conference ID in response to the received conference attendance request. Then, the conference system 300 returns a conference attendance notification to the information terminal 102-2 through the network N (S327). In addition, the conference system 300 considers that the remote attendee U2 has succeeded in authentication when attending the conference, and transmits an authentication result including the user ID, the conference ID, and the system ID of the remote attendee U2 to the conference support apparatus 400 through the network N (S328). In response to this, the conference support apparatus 400 acquires an authentication result from the conference system 300 through the network N, and performs conference support processing according to FIG. 12 described above (S329).

That is, the conference support apparatus 400 acquires the authentication result from the conference system 300 through the network N (S411). Then, the conference support apparatus 400 acquires the current attendance status display information in the target conference ID stored in the previous conference support processing (S317 in FIG. 9) (S412). Then, the conference support apparatus 400 determines that the acquisition source is the conference system 300 from the system ID included in the acquired authentication result, and determines the attendance form of the remote attendee U2 as “remote attendance” (S413). Then, similarly to the above, steps S414 to S416 are performed.

Then, the conference support apparatus 400 determines whether the target online conference has started (S417). At this point in time, since the conference has been started by the organizer, it is determined that the online conference has started (YES). Therefore, the conference support apparatus 400 determines non-attendees from the current attendance status display information and the scheduled attendee list (S418). For example, at this point in time, since the conference room attendee U1-1 and the remote attendee U2 in the attendance status display information are attendees, the conference support apparatus 400 determines that the other scheduled attendees in the scheduled attendee list are non-attendees. Therefore, the conference support apparatus 400 updates the attendance status display information by classifying scheduled attendees into any one of conference room attendance, remote attendance, and non-attendee (S419). Note that the attendance form of the conference room attendee U1-1 may be determined as both “conference room attendance” in step S317 and “remote attendance” in step S319. In this case, the conference support apparatus 400 may give priority to “conference room attendance” in the attendance form. That is, the conference support apparatus 400 may update the attendance status display information by setting the attendance form of the conference room attendee U1-1 as “conference room attendance”. Then, the conference support apparatus 400 outputs the updated attendance status display information (S420).

Specifically, the conference support apparatus 400 transmits the attendance status display information to each of the information terminal 102-1 and the information terminal 102-2 through the network N (S330 and S331 in FIG. 10). In response to this, the information terminal 102-2 displays the received attendance status display information on the screen (S332). In addition, the information terminal 102-1 displays the received attendance status display information on the screen (S333), and outputs the attendance status display information to the display apparatus 103 (S334). In response to this, the display apparatus 103 displays the attendance status display information received from the information terminal 102-1 on the screen (S335).

Thereafter, another scheduled attendee U0 (for example, a subsequent conference room attendee U1-2) at the base 61 goes to the conference room 611 and performs personal authentication with the authentication terminal 101 in order to attend the online conference started by the conference room attendee U1-1. Specifically, the authentication terminal 101 captures an image of the face of an entering person who intends to enter the conference room 611 (S341). Then, the authentication terminal 101 transmits a face authentication request including the face image to the authentication apparatus 200 through the network N (S342). In response to this, the authentication apparatus 200 performs face authentication processing (S343).

The information terminal 102 receives the face authentication result from the authentication apparatus 200 through the network N (S344). Here, it is assumed that the scheduled attendee U0 has succeeded in the face authentication. Therefore, the authentication terminal 101 unlocks the door 104 of the conference room 611 to permit the scheduled attendee U0 to enter the room (S345). In this case, it is assumed that the scheduled attendee U0 is called a conference room attendee U1-2 in the conference room 611. The authentication terminal 101 transmits the authentication result including the user ID included in the face authentication result and the terminal ID of the authentication terminal 101 to the conference support apparatus 400 through the network N (S346). In response to this, the conference support apparatus 400 acquires the authentication result from the authentication terminal 101 through the network N, and performs conference support processing according to FIG. 12 described above (S347).

That is, the conference support apparatus 400 acquires the authentication result from the conference system 300 through the network N (S411). Then, the conference support apparatus 400 acquires the current attendance status display information in the target conference ID stored in the previous conference support processing (S329 in FIG. 9) (S412). Then, the conference support apparatus 400 determines that the acquisition source is the authentication terminal 101 from the terminal ID included in the acquired authentication result, and determines the attendance form of the conference room attendee U1-2 as “conference room attendee” (S413). Then, similarly to the above, steps S414 to S416 are performed.

Then, it is determined that the online conference has started (YES in S417), and the conference support apparatus 400 determines non-attendees from the current attendance status display information and the scheduled attendee list (S418). Here, since the conference room attendee U1-2 is also an attendee in addition to the conference room attendee U1-1 and the remote attendee U2, the conference support apparatus 400 determines that the other scheduled attendees in the scheduled attendee list are non-attendees. Therefore, the conference support apparatus 400 updates the attendance status display information by classifying scheduled attendees into any one of conference room attendance, remote attendance, and non-attendee (S419). Here, the conference support apparatus 400 classifies the conference room attendees U1-1 and U1-2 into an attendance form “conference room attendance”, classifies the remote attendee U2 into an attendance form “remote attendance”, and classifies the other scheduled attendees into “non-attendees”. Then, the conference support apparatus 400 outputs the updated attendance status display information (S420).

Specifically, the conference support apparatus 400 transmits the attendance status display information to each of the information terminal 102-1 and the information terminal 102-2 through the network N (S350 and S351 in FIG. 10). In response to this, the information terminal 102-2 displays the received attendance status display information on the screen (S352). In addition, the information terminal 102-1 displays the received attendance status display information on the screen (S353), and outputs the attendance status display information to the display apparatus 103 (S354). In response to this, the display apparatus 103 displays the attendance status display information received from the information terminal 102-1 on the screen (S355).

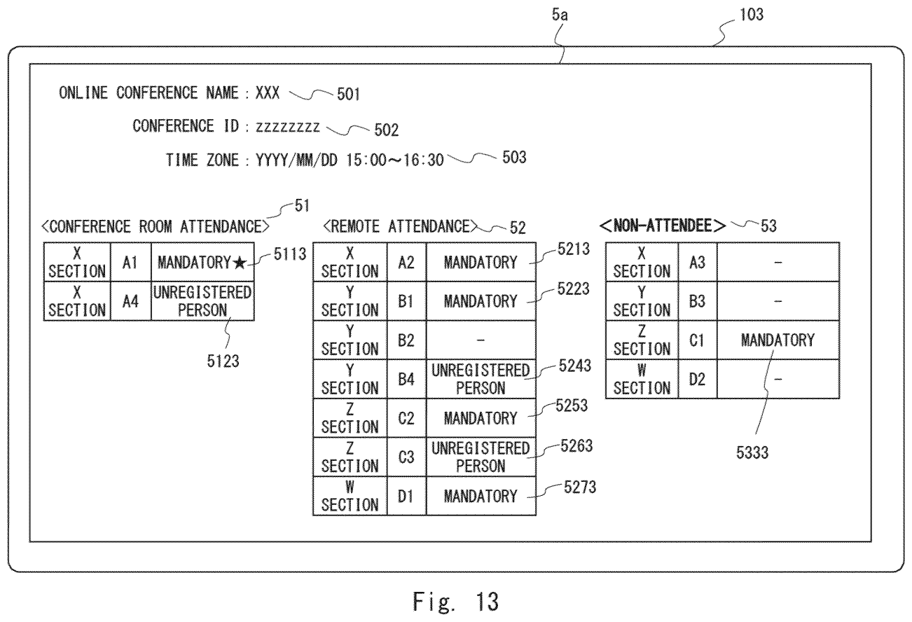

FIG. 13 is a diagram illustrating a display example of attendance status display information 5a according to the second example embodiment. Here, an example is illustrated in which the attendance status display information 5a is displayed on the display apparatus 103. The attendance status display information 5a includes a conference name 501, a conference ID 502, a time zone 503, attendance form display portions 51 and 52, and an non-attendee display portion 53. The conference name 501 is the conference name 312 in the corresponding conference information 310. The conference ID 502 is the conference ID 311 in the corresponding conference information 310. The time zone 503 is the time zone 313 in the corresponding conference information 310.

The attendance form display portion 51 is a field for displaying a list of attendees whose attendance form is “conference room attendance”. In the list of attendees, for example, a belonging group name, a user name, and an attribute are displayed for each attendee. For example, the attribute 5113 indicates that A1 in the X section is a mandatory attendee and an organizer of the conference. The attribute 5123 indicates that A4 in the X section is an unregistered person in the scheduled attendee list of the conference.

The attendance form display portion 52 is a field for displaying a list of attendees whose attendance form is “remote attendance”. The configuration of the list of attendees is similar to that of the above-described attendance form display portion 51, but is not limited thereto. Attributes 5213, 5223, 5253, and 5273 indicate that the corresponding remote attendees are mandatory attendees at the conference. Conversely, B2 in the Y section indicates that the attribute is “-” and the person is any attendee at the conference. Attributes 5243 and 5263 indicate that the remote attendee is an unregistered person in the scheduled attendee list of the conference.

The non-attendee display portion 53 is a field for displaying a list of non-attendees among the scheduled attendees in the scheduled attendee list. Here, it is indicated that four persons are non-attendees, that is, four persons do not attend the online conference at the present time. The attribute 5333 indicates that the corresponding non-attendee C1 is a mandatory attendee at the conference. Then, the other three non-attendees have an attribute of “-”, indicating that they are any attendees at the conference.

In this manner, due to the attendance status display information 5a, the conference room attendees A1 and A4 in the conference room 611, the remote attendee A2 in another base, and the like can view the current attendance status of the target online conference through each screen. That is, it is possible to easily grasp the groups and user names of attendees and non-attendees of the online conference. For example, it is easy to recognize that four persons A3, B3, C1, and D2 have not attended at the present time. In addition, among the attendees, the conference room attendees and the remote attendees can be easily grasped from the list. For example, it is possible to easily grasp that A1 and A4 indicate conference room attendance but A2 indicates remote attendance even in the same X section. In addition, it is possible to easily grasp that all the mandatory attendees are present according to the attributes. Therefore, it is possible to support the determination of the start of the conference by the organizer of the conference. In addition, it is possible to easily grasp that an unregistered person is included in the attendees by the attributes. As a result, it is possible to recognize that a person other than the original scheduled attendees is present.

Next, a means for changing the attribute display of the attendance status display information when an unregistered person attends the online conference will be described. In the present example embodiment, for example, it is assumed that a superior, a relevant person, and an absentee in the same department of the unregistered person can give attendance permission together with the reason for attendance of the unregistered person.

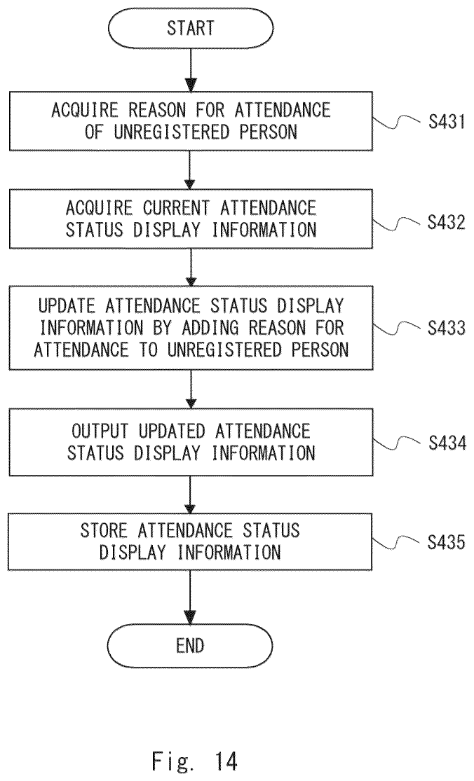

FIG. 14 is a flowchart illustrating a flow of attendance permission processing of an unregistered person according to the second example embodiment. Here, in the example of FIG. 13, since A4 in the X section attends as an unregistered person, a non-attendee (an absentee) A3 in the X section applies for the attendance permission including the reason for attendance (proxy attendance) of A4. Specifically, the information terminal 102-1 receives from the non-attendee A3 a designation that the reason for attendance of the unregistered person A4 is proxy attendance for the original scheduled attendee A3, and transmits attendance permission including the reason for attendance of the unregistered person A4 to the conference support apparatus 400 through the network N. In response to this, the conference support apparatus 400 acquires the reason for attendance of the unregistered person A4 from the information terminal 102-1 through the network N (S431).

Then, similarly to step S412 described above, the conference support apparatus 400 acquires the current attendance status display information in the target conference ID (S432). Then, the conference support apparatus 400 updates the attendance status display information by adding the reason for attendance to the unregistered person (S433). For example, the conference support apparatus 400 adds a notation indicating “proxy attendance for scheduled attendee A3” as a reason for attendance of the unregistered person A4. Then, the conference support apparatus 400 outputs the updated attendance status display information (S434). Then, the conference support apparatus 400 stores the updated attendance status display information (S435).

In the above example, the absentee A3 himself or herself applied for attendance permission including the reason for attendance of the unregistered person A4 as his/her proxy attendance. However, the applicant for the attendance permission of the unregistered person A4 may be an attendee A1 in the same department as A3 and A4, another scheduled attendee included in the scheduled attendee list, or a person who is a relevant person of A3 and A4 and is not a scheduled attendee.

In addition, additional attendance can be mentioned as another example of the reason for attendance of an unregistered person. For example, since the unregistered person B4 in the Y section attends in the example of FIG. 13, the attendee B1 in the Y section applies for the attendance permission including the reason for attendance (additional attendance) of the subordinate B4. In this case, in step S433, the conference support apparatus 400 adds a notation indicating “subordinate of B1, additional attendance” as a reason for attendance of the unregistered person B4. Note that the applicant for the attendance permission of the unregistered person B4 may be another attendance in the same department as B4, another scheduled attendee included in the scheduled attendee list, or a person who is a relevant person of B1 and B4 and is not a scheduled attendee.

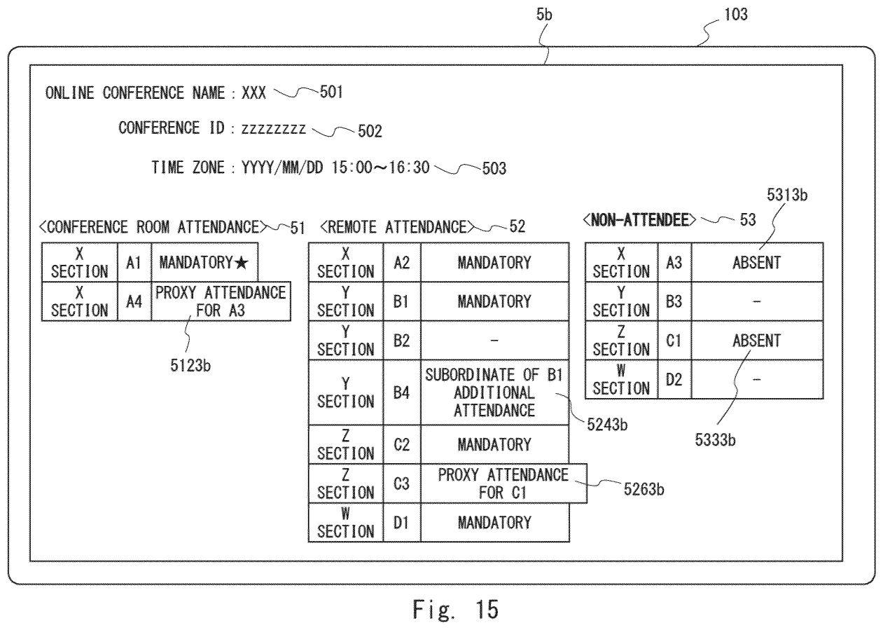

FIG. 15 is a diagram illustrating a display example of attendance status display information 5b according to the second example embodiment. The attendance status display information 5b indicates an example in which the attendance reason is added to the unregistered persons A4, B4, and C3 in the attendance status display information 5a of FIG. 13 described above. Specifically, the attribute 5123b indicates that the reason for attendance of A4 in the X section is “proxy attendance for A3 (absentee)”. In addition, the attribute 5243b indicates that the reason for attendance of B4 in the Y section is “subordinate of B1” and “additional attendance”. In addition, the attribute 5263b indicates that the reason for attendance of C3 in the Z section is “proxy attendance for C1”. In addition, the attributes 5313b and 5333b indicate that the reasons for absence of A3 in the X section and C1 (mandatory attendee) in the Z section are “absence”. Therefore, since there is no indication of the reason for absence for the other non-attendees B3 and D2 described in the non-attendee display portion 53, it is possible to grasp that the reason for absence is unknown.

First, if the attendees are conference room attendance, the organizer of the conference can easily grasp whether the attendees are present or absent by looking around the room, and for the persons absent in the conference room, the organizer can easily grasp whether the persons absent in the conference room are remote attendance or absent by viewing the attendance status display information displayed on the display apparatus 103 or the like. Similarly, the remote attendees are not present in the online conference system, but it is possible to grasp whether the attendees are conference room attendees or absent by viewing not only the video of the conference system but also the attendance status display information for the attendees in the conference room. In addition, as described above, it is possible to easily grasp the reason for attendance such as proxy attendance for a non-attendee or additional attendance regardless of the attendance form. For example, when 30 persons are registered in the scheduled attendee list, it is possible to easily grasp the attendance form such as 15 persons attending in the conference room, 10 persons in remote attendance, and 5 persons absent, and the breakdown of non-attendees.

In addition, in the above description, an example has been described in which an unregistered person can attend a conference room or remotely attend an online conference. However, an unregistered person may not be allowed to enter the online conference or log in. Then, in this case, the unregistered person may be allowed to enter the online conference or log in when the attendance is permitted together with the attendance reason described later.

In addition, when there are mandatory attendees, the conference support apparatus 400 according to the present example embodiment may notify the organizer of the conference of the fact. That is, the determination unit 443 determines whether all the mandatory attendees set in the scheduled attendee list are included in the attendees at the online conference. Then, when all the mandatory attendees are included, the output unit 445 notifies the organizer of the online conference that the conference can be started. As a result, even if there are some non-attendees in the non-attendee display portion 53 of the attendance status display information, the organizer can easily make a determination to start the conference. In addition, even if there is a non-attendee or an absentee among the mandatory attendees, if there is a proxy attendee for the mandatory attendee, the organizer similarly easily makes a determination to start the conference. Therefore, it is possible to save time and effort to check attendance within the limited conference time. In addition, even if there is an unregistered person, the reason for attendance can be known. Therefore, it is easy to determine whether a person who is not qualified to attend the conference is included. Therefore, risks such as information leaks can be reduced.

In addition, in the present example embodiment, personal authentication may be also performed when leaving the conference room 611, and the fact may be determined as attendance status display information. For example, it is assumed that an authentication terminal for unlocking the door 104 is installed in the conference room 611. Then, it is assumed that the face of the conference room attendee U1-3 in the conference room 611 is captured by the authentication terminal in the room when leaving the room. In this case, the authentication terminal performs personal authentication on the conference room attendee U1-3, and transmits the authentication result to the conference support apparatus 400 through the network N. Then, the acquisition unit 442 acquires the second authentication result of the personal authentication when the conference room attendee U1-3 whose attendance form is conference room attendance leaves the conference room 611. Then, the update unit 444 updates the attendance status display information so that it can be identified in the second authentication result that the attendee U1-3 has left the online conference. For example, since a remote attendee who leaves the online conference can be grasped by the online conference system, the attendees can relatively easily grasp the person leaving the online conference in the middle of the online conference. On the other hand, since the conference room attendees according to the present example embodiment are not necessarily subjected to the conference attendance processing in the online conference system, leaving in the middle of the online conference is not detected. Therefore, by reflecting the result of the personal authentication at the time of leaving in the attendance status display information described above, other attendees, particularly remote attendees, can easily grasp the person leaving the conference room in the middle of the conference. In addition, when the conference support apparatus 400 receives a notification about a remote attendee who leaves the online conference from the online conference system, the notification may be reflected on the attendance status display information.

In addition, as a modified example of the present example embodiment, the display apparatus is not limited to one installed in the conference room 611 as illustrated in FIG. 3, and may be installed outside the conference room of the conference room 611. In this case, the output unit 445 may output the attendance status display information to a display apparatus 103-2 installed outside the conference room 611 through the network N.

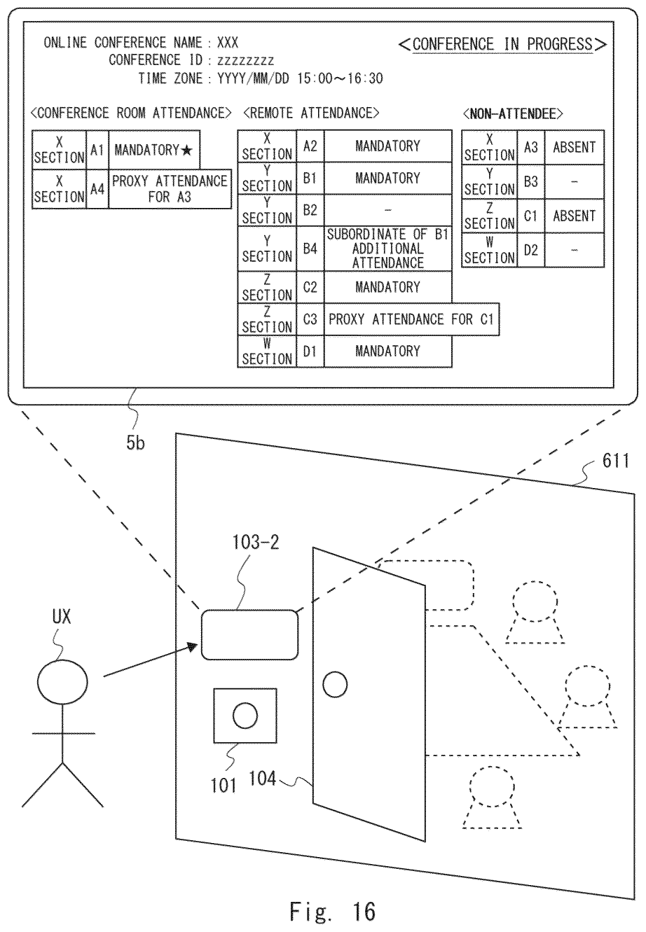

FIG. 16 is a diagram for describing a concept of display of the attendance status display information 5b according to a modified example of the second example embodiment. On the outer wall of the conference room 611, the authentication terminal 101 and the display apparatus 103-2 are installed near the door 104 which is an entrance. The authentication terminal 101 and the display apparatus 103-2 are connected to the network N. Note that the display apparatus 103-2 may be connected to the information terminal 102-1 in the conference room 611. The display apparatus 103-2 displays the attendance status display information 5b. In the attendance status display information 5b, “conference in progress” is displayed. It is assumed that a conference non-attendee UX has come to the front of the conference room 611 because there is a need for the conference attendee A1. At this time, by viewing the attendance status display information 5b, the conference non-attendee UX can check that the attendee A1 is attending the conference, the scheduled end time of the conference, and other attendees, particularly remote attendees. For example, the conference non-attendee UX can check the scheduled end time of the conference, visit the conference room 611 again, and plan to discuss the matter with A1 when he leaves the room to start working on other tasks.

In addition, in the present example embodiment, all the persons entering the conference room 611 enter the room after succeeding in the personal authentication by the authentication terminal 101, but the invention is not limited thereto. For example, when a plurality of persons who desire to enter the room collectively enter the conference room 611, the other persons who desire to enter the room may enter the room together if the representative succeeds in personal authentication. However, in this case, a camera installed in the room of the conference room 611 may capture an image of an entering person and output the captured image to the authentication terminal 101, and thereafter, the authentication terminal 101 may perform the face authentication for each face region of each person in the captured image one by one. Alternatively, a terminal having the same function as the authentication terminal 101 may be installed in the room of the conference room 611, and each person entering the room may perform the face authentication after entering the room.

Another application of the present example embodiment is effective use of an empty conference room. For example, when it is unclear whether an unused conference room is reserved, several users of the conference room perform face authentication, so that the attendance status display information is displayed on the display apparatus 103-2 installed on the outer wall of the conference room 611. At this time, the conference support apparatus 400 generates the attendance status display information from the latest scheduled attendee list of the conference room and each authentication result. If there is no latest scheduled attendee list, all the persons who have performed the face authentication are displayed as unregistered persons and the non-attendees are not displayed in the attendance status display information. Therefore, the conference room is not reserved, and it can be easily determined that the conference room is available. As a result, effective use of the conference room is promoted.

### Third Example Embodiment

A third example embodiment is a modified example of the second example embodiment described above. In the third example embodiment, it is possible to support the start and progress of the conference by displaying the expected attendance of non-attendees, notifying relevant persons, and the like. In addition, since the configuration and the like of the conference support system according to the third example embodiment are equivalent to those described above, illustration and redundant description are omitted.

The output unit 445 according to the third example embodiment notifies a relevant person of a non-attendee that the non-attendee has not attended the online conference. As a result, it is possible to grasp a relevant person, for example, a supervisor of the non-attendee, and it is possible to support a quick response. In addition, the acquisition unit 442 may acquire the position information of the non-attendee. In this case, the conference support apparatus 400 further includes an estimation unit that estimates expected attendance information regarding the likelihood that the non-attendee will attend the online conference based on the position information. Then, the update unit 444 updates the attendance status display information by adding the expected attendance information to the non-attendee. Here, the expected attendance information is, for example, information indicating a status such as whether the non-attendee is moving to a conference room or a place where a remote attendance facility is present, whether the non-attendee is attending another conference, or whether the non-attendee is not moving and does not seem to have an intention of attendance, and the expected time of attendance. As a result, the organizer of the conference and other attendees can consider the discussion, the order of the conference, and the like according to the expected attendance of the absent. In some cases, it is possible to proceed with the conference by checking the intention of the non-attendee to attend and clarifying whether or not the non-attendee is absent. In particular, the estimation unit may estimate an expected time at which the non-attendee will attend the online conference as the expected attendance information. As a result, it becomes easy for the conference attendees to determine whether to wait for the arrival of the non-attendee or the like.

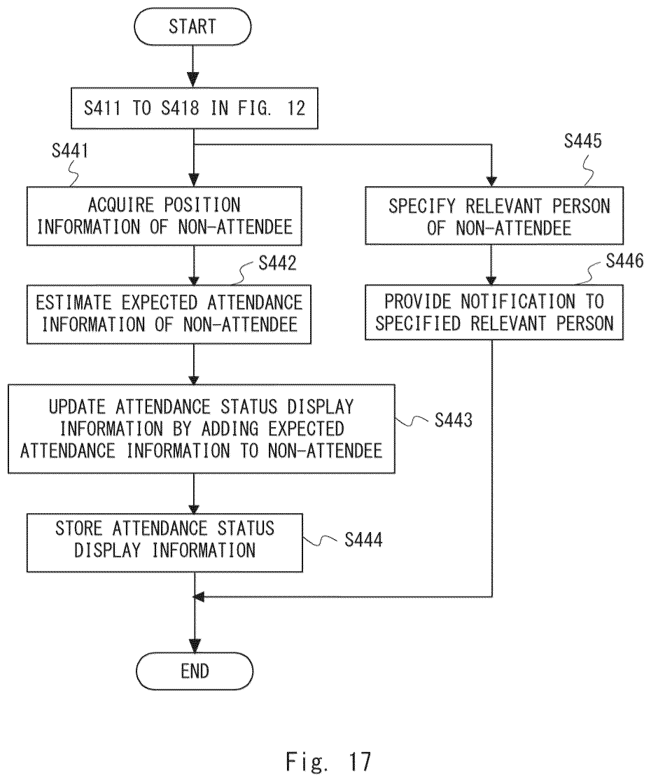

FIG. 17 is a flowchart illustrating a flow of conference support processing in the conference support apparatus according to the third example embodiment. First, steps S411 to S418 in FIG. 12 described above are performed. Thereafter, the acquisition unit 442 acquires the position information of a non-attendee (S441). For example, the acquisition unit 442 may search for a mobile terminal possessed by the non-attendee to acquire the position information. Then, the estimation unit estimates the expected attendance information of the non-attendee (S442). For example, the estimation unit analyzes the transition of the position information of the non-attendee within a predetermined period, and refers to the schedule of the non-attendee. For example, when the transition of the position information of the non-attendee is heading to a conference room in any base or a seat where remote attendance is possible, the estimation unit estimates that there is a high possibility that the non-attendee is moving to attend the conference. Alternatively, when the transition of the position information of the non-attendee is constant within a predetermined period, the estimation unit estimates that there is a possibility that the non-attendee remains at the same place, the non-attendee is participating in another conference, the non-attendee is taking in another conference in business, or the non-attendee forgets the schedule of the conference. In addition, the estimation unit may estimate the expected attendance time of the non-attendee from the scheduled end time during participation from the schedule of the non-attendee, the distance from the current position to the conference room or the like, and the like.

Then, the update unit 444 updates the attendance status display information by adding the expected attendance information to the non-attendee (S443). Then, the output unit 445 stores the updated attendance status display information (S444).

In addition, independently of steps S441 to S444, the conference support apparatus 400 specifies a relevant person of the non-attendee (S445). For example, the conference support apparatus 400 may refer to the user information 412 to specify a user of which the position 4124 is higher in the same group as the belonging group 4123 associated with the user ID of the non-attendee as the relevant person. Then, the conference support apparatus 400 provides the terminal of the specified relevant person with notification that the non-attendee does not attend the online conference (S446). As a result, it is possible to inquire of the relevant person whether or not the non-attendee is absent, or it is possible to encourage the relevant person to attend the conference when the person has forgotten the conference. Therefore, it is easy to quickly grasp the attendance or the expected attendance of the non-attendee. In addition, in this case, the update unit 444 may update the attendance status display information with the expected attendance information of the non-attendee as “checking with the relevant person”.

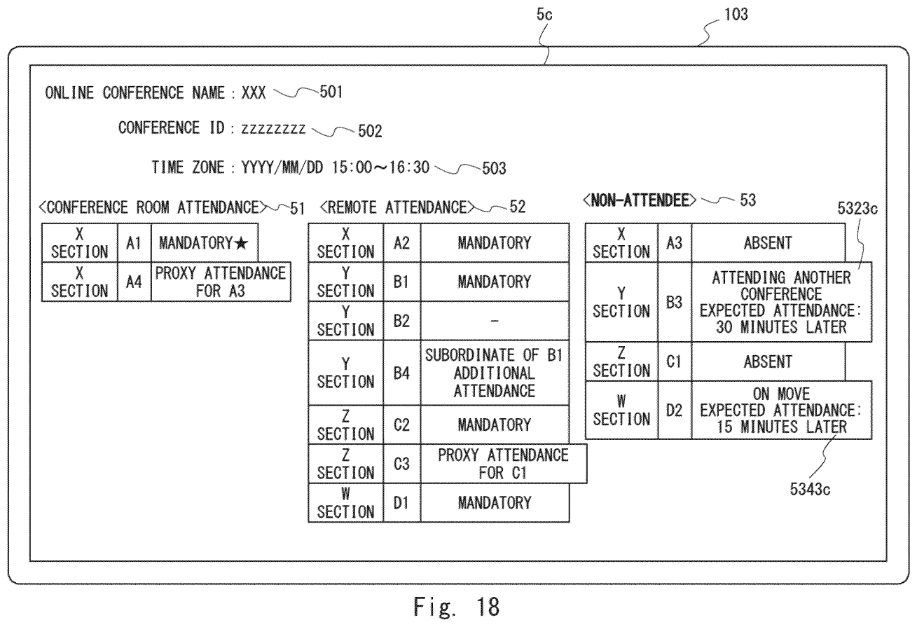

FIG. 18 is a diagram illustrating a display example of attendance status display information 5c according to the third example embodiment. The attendance status display information 5c illustrates an example in which the expected attendance information is added to the non-attendees B3 and D2 in the attendance status display information 5b of FIG. 15 described above. Specifically, the attribute 5323c indicates that B3 in the Y section is “attending another conference” and “expected attendance: 30 minutes later”. In addition, the attribute 5343c indicates that D2 in the W section is “on the move” and “expected attendance: 15 minutes later”. In addition, when the relevant person B3 or D2 of the non-attendee is notified by step S446 described above, a description of “checking with the relevant person in the same department” may be displayed in the attribute of the non-attendee in the attendance status display information 5c. Since the expected attendance of the non-attendee is displayed in this manner, it is easy for the attendees, particularly the conference organizer, to grasp whether the non-attendee is about to come to the conference room, is about to attend remotely, or is highly likely to forget the conference. Therefore, it is easy for the relevant person of the non-attendee among the attendees to consider whether to perform proxy attendance for the non-attendee and the like and respond accordingly. In addition, the organizer of the conference can easily determine the start of the conference, the order of proceeding, and the like.

### Fourth Example Embodiment

A fourth example embodiment is a modified example of the second or third example embodiment described above. In the third example embodiment, by displaying the attendance status display information for each belonging group for the relevant persons of each group, it is possible to easily grasp the attendance status of one's own group and promote a necessary response. In addition, since the configuration and the like of the conference support system according to the fourth example embodiment are equivalent to those described above, illustration and redundant description are omitted.

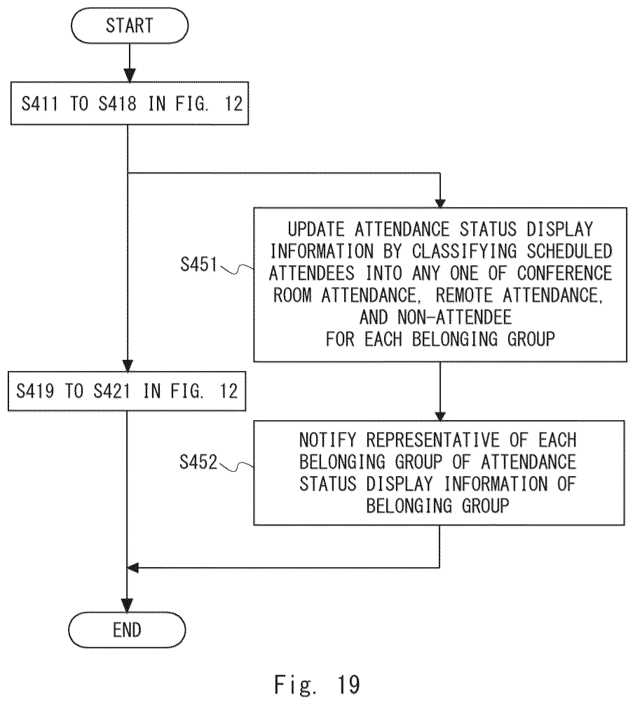

FIG. 19 is a flowchart illustrating a flow of conference support processing in the conference support apparatus according to the fourth example embodiment. First, steps S411 to S418 in FIG. 12 described above are performed. Thereafter, the following processing is performed independently of steps S419 to S421. First, the update unit 444 according to the fourth example embodiment updates the attendance status display information so that each scheduled attendee included in the scheduled attendee list is classified into any one of conference room attendance, remote attendance, and non-attendee for each belonging group (S451). For example, the update unit 444 classifies each scheduled attendee for each belonging group with reference to the scheduled attendee list 315 and the belonging group 4123 of the user information 412. Then, the update unit 444 selects a specific belonging group, and updates the attendance status display information for the selected belonging group so that each scheduled attendee is classified into any one of conference room attendance, remote attendance, and non-attendee. The update unit 444 similarly updates the attendance status display information for the remaining belonging groups.

Then, the output unit 445 according to the fourth example embodiment notifies the representative of each belonging group of the attendance status display information in the belonging group of the representative (S452). For example, the output unit 445 specifies a user whose position 4124 in the selected belonging group 4123 is higher in the user information 412 as a representative. Then, the output unit 445 transmits the attendance status display information in the belonging group to the specified representative and the terminal of the representative. In step S452, notification may be given to the representative of the belonging group to which the unregistered person or the non-attendee belongs.

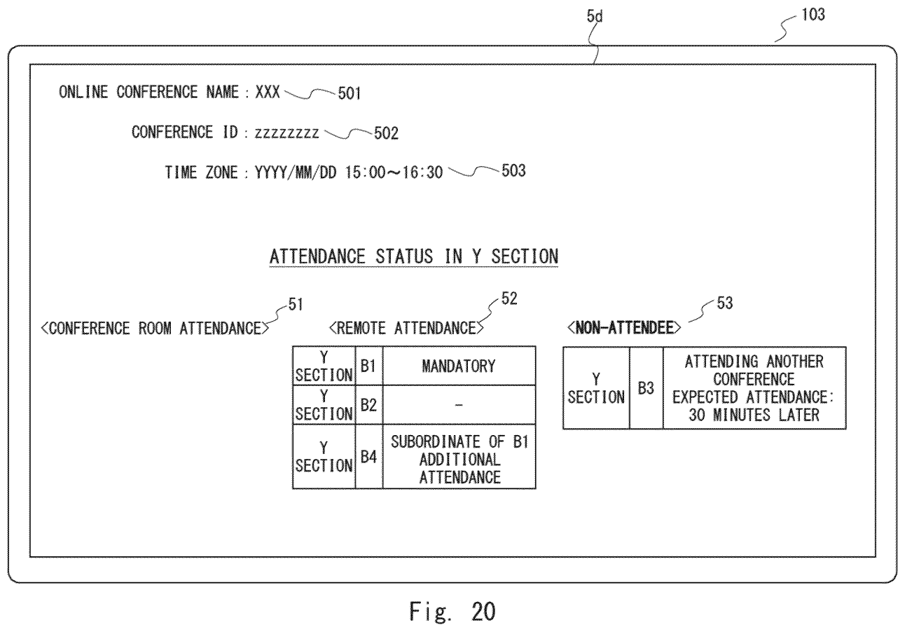

FIG. 20 is a diagram illustrating a display example of attendance status display information 5d according to the fourth example embodiment. The attendance status display information 5d is an example in which information about users in the Y group is extracted from the attendance status display information 5c in FIG. 18 described above. The representative of the Y section can grasp from the attendance status display information 5d that the mandatory attendee B1 will attend, B2 and B4 will also attend, and B3 will be late for the conference 30 minutes. Therefore, the representative of the Y section can take necessary measures depending on the attendance status.

### Other Example Embodiments

Note that the attendance status display information illustrated in FIGS. 13, 15, and 18 described above may be open to all the attendees and relevant persons. Alternatively, the attendance status display information may be open only to the organizer, and may not be open to other attendees or relevant persons. Alternatively, the attendance status display information may be open to the organizer and mandatory attendees, and may not be open to any attendees or unregistered people.

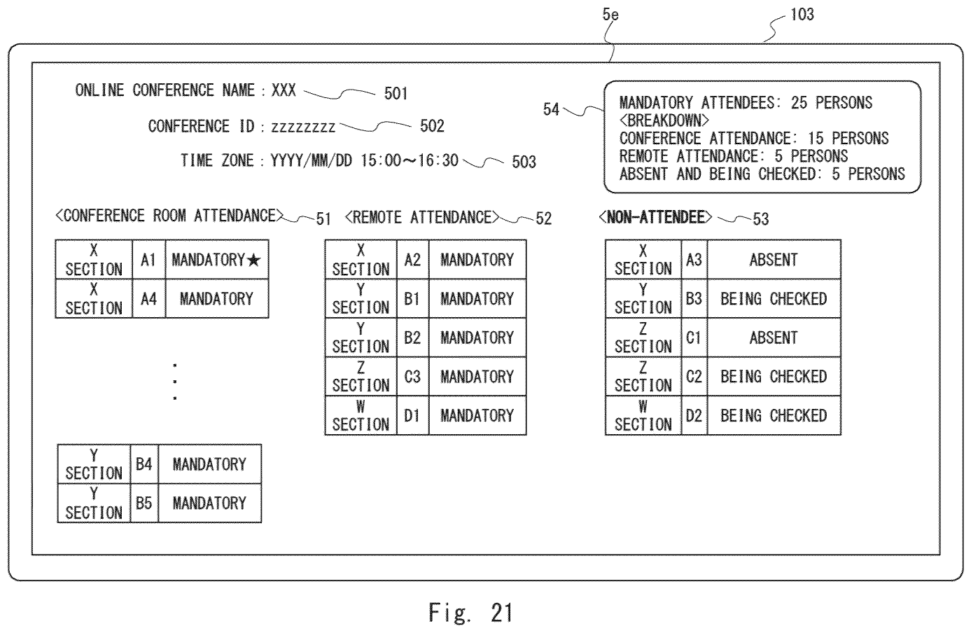

In addition, the attendance status display information may display statistical number-of-people data. Specifically, the update unit 444 may perform updating by counting the number of mandatory attendees for each of conference room attendance, remote attendance, absence, and being checked and adding the total number of mandatory attendees and the counted number of people to the attendance status display information as statistical information. FIG. 21 is a diagram illustrating a display example of attendance status display information 5e according to another example embodiment. The attendance status display information 5e is obtained by adding the statistical information 54 to the above-described attendance status display information 5a and the like. The statistical information 54 indicates that 15 out of the 25 mandatory attendees are conference room attendees, 5 are remote attendees, and 5 are absent or being checked.

Note that the present example embodiment can also be expressed from the following viewpoint. That is, a conference support apparatus includes: an acquisition means for acquiring a first authentication result of an attendee specified by personal authentication when attending an online conference including attendance in a conference room and remote attendance from outside the conference room; a determination means for determining an attendance status of each scheduled attendee included in a scheduled attendee list of the online conference based on the scheduled attendee list and the first authentication result; an update means for updating attendance status display information reflecting the attendance status for each scheduled attendee; and an output means for outputting the attendance status display information.

In addition, in the above-described example embodiment, the personal authentication (authentication of identity confirmation, identity authentication, identity identification processing, and the like) has been described as face authentication, but another biometric authentication using biometric information may be used. As the biometric authentication and the biometric information, other techniques using a captured image of a person can be applied. For example, as the biometric information, data (feature amount) calculated from physical characteristics unique to an individual such as a fingerprint, a voiceprint, a vein, a retina, an iris of a pupil, and a pattern (pattern) of a palm may be used. For the biometric authentication, feature information indicating the physical characteristics of a person may be extracted from the captured image of a part of the body of the user, the extracted feature information may be compared with feature information registered in advance, and the authentication may be regarded as being successful when the degree of matching is equal to or greater than the threshold value. For example, the biometric authentication may be authentication based on the appearance shape of the person. In this case, the feature information is information regarding the appearance shape of the person, for example, information indicating features such as a body shape, a height, and clothes. In addition, instead of the biometric authentication, another personal authentication may be applied, and the biometric information may also be another personal authentication information. Examples of the personal authentication information include, but are not limited to, a combination of a user ID, an ID, and a password, description contents (an identification number and the like or a password) of an identification card such as an individual number and a driver's license, an electronic certificate, code information, and the like. The code information may be a two-dimensional code, for example, a QR code (registered trademark).

Note that the conference room 611 is not limited to one using a camera as the authentication terminal 101. The authentication terminal 101 may perform personal authentication by holding an IC card on which personal authentication information is recorded or by reading code information displayed on the user terminal or code information printed on paper. Alternatively, a camera or the like installed in the conference room 611 may be used as the authentication terminal 101. Note that two or more authentication terminals 101 may be installed in the conference room 611. In addition, personal authentication for remote attendance is not limited to biometric authentication, and an ID and a password may be used.

In addition, in the above-described second to fourth example embodiments, the authentication apparatus 200 and the conference support apparatus 400 have been described as different information processing apparatuses, but may be the same. For example, the conference support apparatus 400 may further register the face feature information in association with the user ID 4121 of the user information 412. In this case, the control unit 440 only needs to further have the functions of the face detection unit 220, the feature point extraction unit 230, the registration unit 240, and the authentication unit 250 in FIG. 4.

In the above-described example, the program includes a group of instructions (or software code) for causing a computer to perform one or more functions described in the example embodiments when being read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage devices. The program may be transmitted on a transitory computer-readable medium or a communication medium. As an example and not by way of limitation, the transitory computer-readable medium or the communication medium includes electrical, optical, acoustic, or other forms of propagated signals.

In addition, the present disclosure is not limited to the above-described example embodiments, and can be appropriately changed without departing from the scope. In addition, the present disclosure may be implemented by appropriately combining the example embodiments.

Some or all of the above-described example embodiments may be described as the following Supplementary Notes, but are not limited to the following.

### Supplementary Note A1

A conference support apparatus including:
an acquisition means for acquiring a first authentication result of an attendee specified by personal authentication when attending an online conference including attendance in a conference room and remote attendance from outside the conference room;
a determination means for determining whether an attendance form of the attendee for the online conference is conference room attendance or remote attendance based on an acquisition source of the first authentication result;
an update means for updating attendance status display information so that the determined attendance form can be identified for the attendee; and
an output means for outputting the attendance status display information.

### Supplementary Note A2

The conference support apparatus according to Supplementary Note A1, wherein the determination means determines the attendance form as conference room attendance when the acquisition source of the first authentication result is an authentication terminal that performs personal authentication at least when entering the conference room, and determines the attendance form as remote attendance when the acquisition source of the first authentication result is a conference system that manages the online conference.

### Supplementary Note A3

The conference support apparatus according to Supplementary Note A1 or A2, wherein the update means updates the attendance status display information by setting the attendance form as the conference room attendance when the attendance form of a specific attendee corresponds to both the conference room attendance and the remote attendance.

### Supplementary Note A4

The conference support apparatus according to any one of Supplementary Notes A1 to A3, wherein
the determination means
determines, based on a scheduled attendee list of the online conference and the first authentication result, an attendance status of each scheduled attendee included in the scheduled attendee list, and
the update means
updates the attendance status display information by reflecting the attendance status for each scheduled attendee.

### Supplementary Note A5

The conference support apparatus according to Supplementary Note A4, wherein
the determination means
determines the attendee to be an unregistered person when the attendee in the first authentication result is not included in the scheduled attendee list, and
the update means
updates the attendance status display information by adding a notation indicating that the attendee is an unregistered person to the unregistered person.

### Supplementary Note A6

The conference support apparatus according to Supplementary Note A5, wherein
the acquisition means
acquires an attendance permission including an attendance reason of the unregistered person from any of scheduled attendees included in the scheduled attendee list, and
the update means
updates the attendance status display information by adding the attendance reason to the unregistered person.

### Supplementary Note A7

The conference support apparatus according to Supplementary Note A6, wherein
the acquisition means
acquires an attendance permission including the attendance reason of the unregistered person as an additional attendance from the attendee other than the unregistered person among the scheduled attendees included in the scheduled attendee list, and
the update means
updates the attendance status display information by adding a notice of the additional attendance to the unregistered person.

### Supplementary Note A8

The conference support apparatus according to Supplementary Note A6 or A7, wherein
the acquisition means
acquires, from an absentee among the scheduled attendees included in the scheduled attendee list, an attendance permission including the attendance reason of the unregistered person as proxy attendance for the absentee, and
the update means
updates the attendance status display information by adding a notice of the proxy attendance for the absentee to the unregistered person.

### Supplementary Note A9

The conference support apparatus according to any one of Supplementary Notes A4 to A8, wherein
the determination means
determines whether or not all of mandatory attendees set in the scheduled attendee list are included in the attendees in the online conference, and
the output means
notifies an organizer of the online conference that the online conference can be started when all of the mandatory attendees are included.

### Supplementary Note A10

The conference support apparatus according to any one of Supplementary Notes A4 to A9, wherein
the determination means
determines a person other than the attendees, among the scheduled attendees included in the scheduled attendee list, as a non-attendee, and
the update means
updates the attendance status display information so that each scheduled attendee included in the scheduled attendee list is displayed by being classified into any one of the conference room attendance, the remote attendance, and the non-attendee.

### Supplementary Note A11

The conference support apparatus according to Supplementary Note A10, wherein the output means notifies a relevant person of the non-attendee that the non-attendee has not attended the online conference.

### Supplementary Note A12

The conference support apparatus according to Supplementary Note A10 or A11, wherein
the acquisition means
acquires position information of the non-attendee,
an estimation means for estimating expected attendance information regarding a likelihood that the non-attendee will attend the online conference based on the position information is further provided, and
the update means
updates the attendance status display information by adding the expected attendance information to the non-attendee.

### Supplementary Note A13

The conference support apparatus according to Supplementary Note A12, wherein the estimation means estimates an expected time at which the non-attendee will attend the online conference as the expected attendance information.

### Supplementary Note A14

The conference support apparatus according to any one of Supplementary Notes A4 to A13, wherein
the update means
updates the attendance status display information so that each scheduled attendee included in the scheduled attendee list is displayed by being classified into any one of the conference room attendance, the remote attendance, and the non-attendee for each belonging group, and
the output means
notifies a representative of each belonging group of the attendance status display information in the belonging group of the representative.

### Supplementary Note A15

The conference support apparatus according to any one of Supplementary Notes A1 to A14, wherein
the acquisition means
acquires a second authentication result of personal authentication when an attendee whose attendance form is the conference room attendance leaves the conference room, and
the update means
updates the attendance status display information so that the leaving of the attendee from the online conference can be identified in the second authentication result.

### Supplementary Note A16

The conference support apparatus according to any one of Supplementary Notes A1 to A15, wherein the output means outputs the attendance status display information to a display apparatus installed outside the conference room.

### Supplementary Note B1

A conference support system including:
an authentication apparatus that performs personal authentication of an attendee of an online conference including attendance in a conference room and remote attendance from outside the conference room; and
a conference support apparatus connected to the authentication apparatus,
wherein the conference support apparatus includes:
an acquisition means for acquiring a first authentication result of an attendee specified by personal authentication when attending the online conference;
a determination means for determining whether an attendance form of the attendee for the online conference is conference room attendance or remote attendance based on an acquisition source of the first authentication result;
an update means for updating attendance status display information so that the determined attendance form can be identified for the attendee; and
an output means for outputting the attendance status display information.

### Supplementary Note B2

The conference support system according to Supplementary Note B1, wherein
the authentication apparatus performs the personal authentication through each of an authentication terminal that performs personal authentication at least when entering the conference room and a conference system that manages the online conference, and
the determination means
determines the attendance form as conference room attendance when the acquisition source of the first authentication result is the authentication terminal, and
determines the attendance form as remote attendance when the acquisition source of the first authentication result is the conference system.

### Supplementary Note C1

A conference support method causing a computer to:
acquire a first authentication result of an attendee specified by personal authentication when attending an online conference including attendance in a conference room and remote attendance from outside the conference room;
determine whether an attendance form of the attendee for the online conference is conference room attendance or remote attendance based on an acquisition source of the first authentication result;
update attendance status display information so that the determined attendance form can be identified for the attendee; and
output the attendance status display information.

### Supplementary Note D1

A non-transitory computer-readable medium storing a conference support program causing a computer to execute:
acquisition processing for acquiring a first authentication result of an attendee specified by personal authentication when attending an online conference including attendance in a conference room and remote attendance from outside the conference room;
determination processing for determining whether an attendance form of the attendee for the online conference is conference room attendance or remote attendance based on an acquisition source of the first authentication result;
update processing for updating attendance status display information so that the determined attendance form can be identified for the attendee; and
output processing for outputting the attendance status display information.

Although the present invention has been described with reference to the example embodiments (and examples, the present invention is not limited to the above-described example embodiments (and examples. Various changes that can be understood by those skilled in the art can be made to the configurations and details of the present invention within the scope of the present invention.

### REFERENCE SIGNS LIST

1 CONFERENCE SUPPORT APPARATUS
11 ACQUISITION UNIT
12 DETERMINATION UNIT
13 UPDATE UNIT
14 OUTPUT UNIT
1000 CONFERENCE SUPPORT SYSTEM
N NETWORK
U USER
U0 SCHEDULED ATTENDEE
U1, U1-1 to U1-5 CONFERENCE ROOM ATTENDEE
U2 to Un REMOTE ATTENDEE
UX CONFERENCE NON-ATTENDEE
61 to 6n BASE
611 CONFERENCE ROOM
101 AUTHENTICATION TERMINAL
102, 102-1 to 102-n INFORMATION TERMINAL
104 DOOR
200 AUTHENTICATION APPARATUS
210 FACE INFORMATION DB
211 USER ID
212 FACE FEATURE INFORMATION
220 FACE DETECTION UNIT
230 FEATURE POINT EXTRACTION UNIT
240 REGISTRATION UNIT
250 AUTHENTICATION UNIT
300 CONFERENCE SYSTEM
301 CONFERENCE INFORMATION DB
310 CONFERENCE INFORMATION
311 CONFERENCE ID
312 CONFERENCE NAME
313 TIME ZONE
3141 CONFERENCE ROOM
314m CONFERENCE ROOM
315 SCHEDULED ATTENDEE LIST
3151 USER ID
3152 MANDATORY FLAG
3153 ORGANIZER FLAG
3154 BELONGING GROUP
3155 USER NAME
400 CONFERENCE SUPPORT APPARATUS
410 STORAGE UNIT
411 PROGRAM
412 USER INFORMATION
4121 USER ID
4122 USER NAME
4123 BELONGING GROUP
4124 POSITION
420 MEMORY
430 COMMUNICATION UNIT
441 REGISTRATION UNIT
442 ACQUISITION UNIT
443 DETERMINATION UNIT
444 UPDATE UNIT
445 OUTPUT UNIT
5, 5a to 5e ATTENDANCE STATUS DISPLAY INFORMATION
501 CONFERENCE NAME
502 CONFERENCE ID
503 TIME ZONE
51 ATTENDANCE FORM DISPLAY PORTION
52 ATTENDANCE FORM DISPLAY PORTION
53 NON-ATTENDEE DISPLAY PORTION
5113, 5123, 5213, 5223, 5243, 5253, 5263, 5273, 5333, 5123b, 5243b, 5263b, 5313b, 5323c, 5333b, 5343c ATTRIBUTE
54 STATISTICAL INFORMATION

What is claimed is:

1. A conference support apparatus comprising:
at least one storage device configured to store instructions; and
at least one processor configured to execute the instructions to:
acquire a first authentication result of an attendee specified by personal authentication when attending an online conference including attendance in a conference room and remote attendance from outside the conference room;
determine whether an attendance form of the attendee for the online conference is conference room attendance or remote attendance based on an acquisition source of the first authentication result;
update attendance status display information so that the determined attendance form is identifiable for the attendee; and
output the attendance status display information.

2. The conference support apparatus according to claim 1, wherein the at least one processor is further configured to execute the instructions to:
determine the attendance form as conference room attendance when the acquisition source of the first authentication result is an authentication terminal that performs personal authentication at least when entering the conference room, and
determine the attendance form as remote attendance when the acquisition source of the first authentication result is a conference system that manages the online conference.

3. The conference support apparatus according to claim 1, wherein the at least one processor is further configured to execute the instructions to:
update the attendance status display information by setting the attendance form as the conference room attendance when the attendance form of a specific attendee corresponds to both the conference room attendance and the remote attendance.

4. The conference support apparatus according to claim 1, wherein the at least one processor is further configured to execute the instructions to:
determine, based on a scheduled attendee list of the online conference and the first authentication result, an attendance status of each scheduled attendee included in the scheduled attendee list, and
update the attendance status display information by reflecting the attendance status for each scheduled attendee.

5. The conference support apparatus according to claim 4, wherein the at least one processor is further configured to execute the instructions to:
determine the attendee to be an unregistered person when the attendee in the first authentication result is not included in the scheduled attendee list, and
update the attendance status display information by adding a notation indicating that the attendee is an unregistered person to the unregistered person.

6. The conference support apparatus according to claim 5, wherein the at least one processor is further configured to execute the instructions to:
acquire an attendance permission including an attendance reason of the unregistered person from any of scheduled attendees included in the scheduled attendee list, and
update the attendance status display information by adding the attendance reason to the unregistered person.

7. The conference support apparatus according to claim 6, wherein the at least one processor is further configured to execute the instructions to:
acquire an attendance permission including the attendance reason of the unregistered person as an additional attendance from the attendee other than the unregistered person among the scheduled attendees included in the scheduled attendee list, and
update the attendance status display information by adding a notice of the additional attendance to the unregistered person.

8. The conference support apparatus according to claim 6, wherein the at least one processor is further configured to execute the instructions to:
acquire, from an absentee among the scheduled attendees included in the scheduled attendee list, an attendance permission including the attendance reason of the unregistered person as proxy attendance for the absentee, and
update the attendance status display information by adding a notice of the proxy attendance for the absentee to the unregistered person.

9. The conference support apparatus according to claim 4, wherein the at least one processor is further configured to execute the instructions to:
determine whether or not all of mandatory attendees set in the scheduled attendee list are included in the attendees in the online conference, and
notify an organizer of the online conference that the online conference is capable of being started when all of the mandatory attendees are included.

10. The conference support apparatus according to claim 4, wherein the at least one processor is further configured to execute the instructions to:
determine a person other than the attendees, among the scheduled attendees included in the scheduled attendee list, as a non-attendee, and
update the attendance status display information so that each scheduled attendee included in the scheduled attendee list is displayed by being classified into any one of the conference room attendance, the remote attendance, and the non-attendee.

11. The conference support apparatus according to claim 10, wherein the at least one processor is further configured to execute the instructions to:
notify a relevant person of the non-attendee that the non-attendee has not attended the online conference.

12. The conference support apparatus according to claim 10, wherein the at least one processor is further configured to execute the instructions to:
acquire position information of the non-attendee,
estimate expected attendance information regarding a likelihood that the non-attendee will attend the online conference based on the position information is further provided, and
update the attendance status display information by adding the expected attendance information to the non-attendee.

13. The conference support apparatus according to claim 12, wherein the at least one processor is further configured to execute the instructions to:
estimate an expected time at which the non-attendee will attend the online conference as the expected attendance information.

14. The conference support apparatus according to claim 10, wherein the at least one processor is further configured to execute the instructions to:
update the attendance status display information so that each scheduled attendee included in the scheduled attendee list is displayed by being classified into any one of the conference room attendance, the remote attendance, and the non-attendee for each belonging group, and
notify a representative of each belonging group of the attendance status display information in the belonging group of the representative.

15. The conference support apparatus according to claim 1, wherein the at least one processor is further configured to execute the instructions to:
acquire a second authentication result of personal authentication when an attendee whose attendance form is the conference room attendance leaves the conference room, and
update the attendance status display information so that the leaving of the attendee from the online conference is identifiable in the second authentication result.

16. The conference support apparatus according to claim 1, wherein the at least one processor is further configured to execute the instructions to:
output the attendance status display information to a display apparatus installed outside the conference room.

17. A conference support system comprising:
an authentication apparatus; and
a conference support apparatus connected to the authentication apparatus, and
wherein the authentication apparatus includes:
at least one first storage device configured to store first instructions; and
at least one first processor configured to execute the first instructions to:
perform personal authentication of an attendee of an online conference including attendance in a conference room and remote attendance from outside the conference room; and
wherein the conference support apparatus includes:
at least one second storage device configured to store second instructions; and
at least one second processor configured to execute the second instructions to:
acquire a first authentication result of an attendee specified by personal authentication when attending the online conference;
determine whether an attendance form of the attendee for the online conference is conference room attendance or remote attendance based on an acquisition source of the first authentication result;
update attendance status display information so that the determined attendance form is identifiable for the attendee; and
output the attendance status display information.

18. The conference support system according to claim 17, wherein the at least one first processor is further configured to execute the first instructions to:
perform the personal authentication through each of an authentication terminal that performs personal authentication at least when entering the conference room and a conference system that manages the online conference, and
wherein the at least one second processor is further configured to execute the second instructions to:
determine the attendance form as conference room attendance when the acquisition source of the first authentication result is the authentication terminal, and
determine the attendance form as remote attendance when the acquisition source of the first authentication result is the conference system.

19. A conference support method causing a computer to:
acquire a first authentication result of an attendee specified by personal authentication when attending an online conference including attendance in a conference room and remote attendance from outside the conference room;
determine whether an attendance form of the attendee for the online conference is conference room attendance or remote attendance based on an acquisition source of the first authentication result;
update attendance status display information so that the determined attendance form is identifiable for the attendee; and
output the attendance status display information.

20. A non-transitory computer-readable medium storing a conference support program causing a computer to execute:
acquisition processing for acquiring a first authentication result of an attendee specified by personal authentication when attending an online conference including attendance in a conference room and remote attendance from outside the conference room;
determination processing for determining whether an attendance form of the attendee for the online conference is conference room attendance or remote attendance based on an acquisition source of the first authentication result;
update processing for updating attendance status display information so that the determined attendance form is identifiable for the attendee; and
output processing for outputting the attendance status display information.
